(19) United States
(12) Patent Application Publication
(10) Pub. No.: US 2019/0100353 A1
(43) Pub. Date: Apr. 4, 2019

(54) ARTICLES AND METHODS PROVIDING LIQUID-IMPREGNATED SCALE-PHOBIC SURFACES

(71) Applicant: Massachusetts Institute of Technology, Cambridge, MA (US)

(72) Inventors: Srinivas Prasad Bengaluru Subramanyam, Cambridge, MA (US); Gisele Azimi, Waltham, MA (US); Jonathan David Smith, Arlington, MA (US); Kripa K. Varanasi, Lexington, MA (US)

(73) Assignee: Massachusetts Institute of Technology, Cambridge, MA (US)

(21) Appl. No.: 15/680,167

(22) Filed: Aug. 17, 2017

Related U.S. Application Data
(63) Continuation of application No. 14/194,110, filed on Feb. 28, 2014, now abandoned.
(60) Provisional application No. 61/922,574, filed on Dec. 31, 2013.
(60) Provisional application No. 61/771,486, filed on Mar. 1, 2013.

(51) Int. Cl. B65D 25/14; F28F 19/00; B05D 7/22

(52) U.S. Cl. CPC B65D 25/14; B05D 7/227; F28F 19/00

(57) ABSTRACT

This invention relates generally to articles, devices, and methods for inhibiting or preventing the formation of scale during various industrial processes. In certain embodiments, a vessel is provided for use in an industrial process, the vessel having a textured, liquid-impregnated surface in contact with a mineral solution, wherein the liquid-impregnated surface comprises a matrix of features spaced sufficiently close to stably contain an impregnating liquid lubricant therebetween or therewithin, wherein the impregnating lubricant has a low surface energy density, and wherein the spreading coefficient S_{os(w)} of the impregnating lubricant (subscript ‘o’) on the substrate (subscript ‘s’) in the presence of the salt solution (subscript ‘w’) is greater than zero, such that the impregnating lubricant fully submerges the textured substrate.

### CROSS-REFERENCE TO RELATED APPLICATIONS

This application claims priority to and the benefit of U.S. Provisional Patent Application Ser. No. 61/922,574, filed Dec. 31, 2013, entitled “Articles and Methods Providing Liquid-Impregnated Scale-Phobic Surfaces,” and U.S. Provisional Patent Application Ser. No. 61/771,486, filed Mar. 1, 2013, entitled “Articles and Methods Providing Liquid-Impregnated Scale-Phobic Surfaces,” the disclosures of which are incorporated herein by reference in their entireties.

### FIELD OF THE INVENTION

This invention relates generally to articles, devices, and methods for inhibiting or preventing the formation of scale on surfaces, and more particularly, to articles, devices, and methods for inhibiting or preventing the formation of mineral scale on surfaces in industrial processes.

### BACKGROUND OF THE INVENTION

Scale formation is a persistent problem encountered in a variety of industries, such as the oil and gas industry, desalination plants, and power plants, among others, and results in a significant loss of efficiency and useful lifetime of process equipment in these industries. For example, scale formation or precipitation fouling of heat exchanger surfaces and oil and gas pipelines are a significant problem. Developing surfaces that have a low affinity to scale has been an area of particular interest in the last decade.

The challenges associated with scale formation have a major effect on the capital and operating costs of most conversion processes. For example, the costs associated with heat exchanger fouling for industrialized countries has been estimated to be about 0.25% of the gross national product (GNP) for these countries. Furthermore, scale formation may play a dramatic role in oil pipelines. For example, scale formation resulted in a shocking loss of production from 30,000 barrels/day to 0 (zero) barrels/day in mere 24 hours in an oil well in the North Sea, as discussed in Crabtree et al., Oilfield Rev. 1999, Autumn, 30.

Among well-known mineral scale deposits, CaSO₄ is a mineral scale deposit encountered in many industrial processes. Besides having low solubility limits, a major difficulty with CaSO₄ is the phase transformation between its hydrates and polymorphs, particularly at elevated temperatures (above 100° C.), which results in a significant reduction of its solubility limits. Furthermore, the solubility of CaSO₄ is strongly affected by the presence and concentrations of other ions in the system. Another challenge with CaSO₄ scale deposits is that they form even at low pH and can be removed effectively only by mechanical means, which significantly increases the operating cost of the plant.

Conventional techniques to remove scale deposits include mechanical and chemical methods. However, these techniques are suboptimal because of the high, often prohibitive, costs involved in the removal process, as well as their environmentally unfriendly nature. For example, conventional methods for scale mitigation involving chemical additives on surfaces can either shift the scale equilibrium conditions or act as inhibitors by increasing scale formation time. Other methods include coating substrates with low surface energy materials to inhibit scale formation. However, such chemical additives and coatings involve polymers, thiols, or silanes, which can deteriorate under harsh environments that are generally encountered during scale formation in various industries, creating an environmental hazard.

Hence, to achieve further advances in economics and efficiency of various processes, there is a need for innovative technologies for scale mitigation and control.

### SUMMARY OF THE INVENTION

Presented herein are liquid-impregnated surfaces that combine the desired properties of low surface energy and low roughness along with a liquid-liquid interface, all of which mitigates scale nucleation and/or growth on the surface. Furthermore, it is shown that standard vessel materials, such as steel (e.g., in some embodiments, the steel is carbon steel or stainless steel), aluminum, copper, or tin, for example, can be inexpensively treated to produce a microtextured surface which is suitable for liquid impregnation. Moreover, an existing industrial vessel can be retrofitted by microtexturing its interior surface, then impregnating the microtextured surface with a low surface-energy impregnating liquid.

Vessels (e.g., tanks or pipes) are presented herein that inhibit the formation of mineral scale deposits thereupon. The vessel has a liquid-impregnated interior surface, wherein the impregnating liquid is stably held within a matrix of micro- or nano-scale (solid) features on the surface, or the impregnating liquid fills pores or other tiny wells (e.g., wells, cavities, hollows, recesses, pits, etc.) on the surface. The impregnating liquid is stably contained and does not leach significantly (or at all) into the contents of the vessel, even when the vessel contains another liquid, such as water. The impregnated lubricant is stabilized by capillary forces arising from the micro- or nano-scopic texture and can impart remarkable mobility to motive phase(s) (e.g., liquid droplets) on the surface.

In certain embodiments, the vessel has a textured, liquid-impregnated surface in contact with a mineral solution, wherein the impregnating lubricant has a low surface energy density, and wherein the spreading coefficient S_{os(w)} of the impregnating lubricant (subscript ‘o’) on the substrate (subscript ‘s’) in the presence of the salt solution (subscript ‘w’) is greater than zero, such that the impregnating lubricant fully submerges the textured substrate.

In one aspect, the present invention relates to a vessel for use in an industrial process, the vessel comprising a liquid-impregnated interior surface, wherein the liquid-impregnated surface includes a matrix of features spaced sufficiently close to stably contain an impregnating liquid therebetween or therewithin (e.g., to contain the impregnating liquid sufficiently well such that small quantities of impregnating liquid lost due to settling, evaporation, and/or dissolution of the impregnating liquid into one or more other phases coming into contact with the surface can be replenished, e.g., via contact with a reservoir containing the impregnating liquid) and the impregnating liquid has a surface energy density γ (as measured at 25° C.) no greater than about 35 mJ/m², (e.g., no greater than about 30 mJ/m², no greater than about 25 mJ/m², or no greater than about 20 mJ/m²), thereby providing resistance to formation of mineral scale deposits thereupon (e.g., when the liquid-impregnated surface of the vessel is in contact with a solution comprising a scale-forming mineral) (e.g., wherein the vessel is designed for use in a process in which the liquid-impregnated surface of the vessel contains, transfers, or is otherwise in contact with a solution comprising a scale-forming mineral) (e.g., wherein the impregnating liquid is immiscible with, or negligibly miscible with, the solution comprising the scale-forming mineral with which the interior surface of the vessel is designed to come into contact).

In certain embodiments, the impregnating liquid is a lubricant and the interior surface is a textured substrate, wherein the liquid-impregnated interior surface of the vessel is configured, during operation, to come into contact with (or maintain contact with) a salt solution comprising a scale-forming mineral (e.g., wherein the vessel is designed for use in a process in which the liquid-impregnated surface of the vessel is in contact with a salt solution comprising a scale-forming mineral, or wherein the vessel contains a salt solution comprising a scale-forming mineral or transfers a salt solution comprising a scale-forming mineral), and wherein the spreading coefficient S_{os(w)} of the impregnating lubricant (subscript ‘o’) on the substrate (subscript ‘s’) in the presence of the salt solution (subscript ‘w’) is greater than zero, such that the impregnating lubricant fully submerges the textured substrate (e.g., state IV in FIG. 1d).

In certain embodiments, the impregnating liquid is a silicone oil. In certain embodiments, the liquid-impregnated surface is a scale-phobic surface that inhibits scale formation thereupon. In certain embodiments, the liquid-impregnated surface includes a (solid) metal. In certain embodiments, the metal is selected from the group consisting of aluminum, steel (e.g., stainless or carbon steel), copper, titanium, tin, or any combinations thereof, alloys thereof, or oxides thereof.

In certain embodiments, the impregnating liquid submerges the surface. In certain embodiments, the liquid-impregnated surface includes a silane coating. In certain embodiments, the silane coating is a member selected from the group consisting of methylsilane, phenylsilane, isobutylsilane, dimethylsilane, tetramethyldisilane, hexylsilane, octadecylsilane, and fluorosilane.

In certain embodiments, the liquid-impregnated surface is textured. In certain embodiments, the liquid-impregnated surface includes micro-scale and/or nano-scale features. In certain embodiments, the features include nanograss.

In certain embodiments, the liquid-impregnated surface is located on an interior wall of a heat exchanger. In certain embodiments, the mineral scale deposits include at least one of calcium sulfate, calcium carbonate, barium sulfate, silica, and/or iron.

In certain embodiments, the vessel is a conduit or receptacle (e.g., pipeline) used in deep sea oil and/or gas recovery.

In certain embodiments, the vessel is a conduit or receptacle of a heat exchanger.

In another aspect, the present invention provides a method of retrofitting a vessel for improved resistance to mineral scale deposits, the method comprising modifying the vessel to produce a liquid-impregnated surface, wherein the liquid-impregnated surface includes a matrix of features spaced sufficiently close to stably contain an impregnating liquid therebetween or therewithin (e.g., to contain the impregnating liquid sufficiently well such that small quantities of impregnating liquid lost due to settling, evaporation, and/or dissolution of the impregnating liquid into one or more other phases coming into contact with the surface can be replenished, e.g., via contact with a reservoir containing the impregnating liquid) and the impregnating liquid has a surface energy density γ (as measured at 25° C.) no greater than about 35 mJ/m², (e.g., no greater than about 30 mJ/m², no greater than about 25 mJ/m², or no greater than about 20 mJ/m²), thereby providing resistance to mineral scale deposits thereupon (e.g., when the liquid-impregnated surface of the vessel is in contact with a solution comprising a scale-forming mineral) (e.g., wherein the vessel is designed for use in a process in which the liquid-impregnated surface of the vessel contains, transfers, or is otherwise in contact with a solution comprising a scale-forming mineral) (e.g., wherein the impregnating liquid is immiscible with, or negligibly miscible with, the solution comprising the scale-forming mineral with which the interior surface of the vessel is designed to come into contact).

In some embodiments, the impregnating liquid is a lubricant and the interior surface is a textured substrate, wherein the liquid-impregnated interior surface of the vessel is configured, during operation, to come into contact with (or maintain contact with) a salt solution comprising a scale-forming mineral (e.g., wherein the vessel is designed for use in a process in which the liquid-impregnated surface of the vessel is in contact with a salt solution comprising a scale-forming mineral, or wherein the vessel contains a salt solution comprising a scale-forming mineral or transfers a salt solution comprising a scale-forming mineral), and wherein the spreading coefficient S_{os(w)} of the impregnating lubricant (subscript ‘o’) on the substrate (subscript ‘s’) in the presence of the salt solution (subscript ‘w’) is greater than zero, such that the impregnating lubricant fully submerges the textured substrate (e.g., state IV in FIG. 1d).

In some embodiments, the impregnating liquid is a silicone oil. In some embodiments, the liquid-impregnated surface is a scale-phobic surface that inhibits scale formation thereupon. In some embodiments, the liquid-impregnated surface includes a (solid) metal. In some embodiments, the metal is selected from the group consisting of aluminum, steel (e.g., stainless or carbon steel), copper, titanium, tin, or any combinations thereof, alloys thereof, or oxides thereof. In some embodiments, the impregnating liquid submerges the surface. In some embodiments, the liquid-impregnated surface includes a silane coating. In some embodiments, the silane coating is a member selected from the group consisting of methylsilane, phenylsilane, isobutylsilane, dimethylsilane, tetramethyldisilane, hexylsilane, octadecylsilane, and fluorosilane, or any combination thereof.

In some embodiments, the liquid-impregnated surface is textured. In some embodiments, the liquid-impregnated surface includes micro-scale and/or nano-scale features. In some embodiments, the features include nanograss.

In some embodiments, the liquid-impregnated surface is located on an interior wall of a heat exchanger. In some embodiments, the mineral scale deposits include at least one of calcium sulfate, calcium carbonate, barium sulfate, silica, and/or iron.

In some embodiments, the vessel is a conduit or receptacle (e.g., pipeline or part of a pipeline) used in deep sea oil and/or gas recovery. In some embodiments, the vessel is a conduit or receptacle of a heat exchanger.

In another aspect, the invention provides a method of using a vessel in an industrial process, the method comprising: (a) providing a vessel comprising a liquid-impregnated surface, wherein the liquid-impregnated surface includes a matrix of features spaced sufficiently close to stably contain an impregnating liquid therebetween or therewithin (e.g., to contain the impregnating liquid sufficiently well such that small quantities of impregnating liquid lost due to settling, evaporation, and/or dissolution of the impregnating liquid into one or more other phases coming into contact with the surface can be replenished, e.g., via contact with a reservoir containing the impregnating liquid) and the impregnating liquid has a surface energy density γ (as measured at 25° C.) no greater than about 35 mJ/m², (e.g., no greater than about 30 mJ/m², no greater than about 25 mJ/m², or no greater than about 20 mJ/m²), thereby providing resistance to mineral scale deposits thereupon (e.g., when the liquid-impregnated surface of the vessel is in contact with a solution comprising a scale-forming mineral); and (b) contacting the liquid-impregnated surface with a solution comprising a scale-forming mineral (e.g., wherein the impregnating liquid is immiscible with, or negligibly miscible with, the solution comprising the scale-forming mineral with which the interior surface of the vessel is designed to come into contact).

In some embodiments, the method includes contacting the liquid-impregnated surface with a reservoir containing the impregnating liquid to replenish any impregnating liquid lost due to settling, evaporation, and/or dissolution into one or more other phases coming into contact with the liquid-impregnated surface.

In some embodiments, the impregnating liquid is a lubricant and the interior surface is a textured substrate, wherein the liquid-impregnated interior surface of the vessel is configured, during operation, to come into contact with (or maintain contact with) a salt solution comprising a scale-forming mineral (e.g., wherein the vessel is designed for use in a process in which the liquid-impregnated surface of the vessel is in contact with a salt solution comprising a scale-forming mineral, or wherein the vessel contains a salt solution comprising a scale-forming mineral or transfers a salt solution comprising a scale-forming mineral), and wherein the spreading coefficient S_{os(w)} of the impregnating lubricant (subscript ‘o’) on the substrate (subscript ‘s’) in the presence of the salt solution (subscript ‘w’) is greater than zero, such that the impregnating lubricant fully submerges the textured substrate (e.g., state IV in FIG. 1d).

In some embodiments, the impregnating liquid is a silicone oil. In some embodiments, the liquid-impregnated surface is a scale-phobic surface that inhibits scale formation thereupon. In some embodiments, the liquid-impregnated surface includes a (solid) metal. In some embodiments, the metal is selected from the group consisting of aluminum, steel (e.g., stainless or carbon steel), copper, titanium, tin, or any combinations thereof, alloys thereof, or oxides thereof. In some embodiments, the impregnating liquid submerges the surface.

In some embodiments, the liquid-impregnated surface includes a silane coating. In some embodiments, the silane coating is a member selected from the group consisting of methylsilane, phenylsilane, isobutylsilane, dimethylsilane, tetramethyldisilane, hexylsilane, octadecylsilane, fluorosilane, or any combination thereof.

In some embodiments, the liquid-impregnated surface is textured. In some embodiments, the liquid-impregnated surface includes micro-scale and/or nano-scale features. In some embodiments, the features include nanograss.

In some embodiments, the liquid-impregnated surface is located on an interior wall of a heat exchanger. In some embodiments, the mineral scale deposits include at least one of calcium sulfate, calcium carbonate, barium sulfate, silica, and/or iron, or any combination thereof.

In some embodiments, the vessel is a conduit or receptacle (e.g., pipeline or part of a pipeline) used in deep sea oil and/or gas recovery. In some embodiments, the vessel is a conduit or receptacle of a heat exchanger (or a portion thereof).

In alternative embodiments of the vessels and methods described herein, the impregnating ‘liquid’ is not a liquid, but rather, is a gel, a semi-solid, or a low surface-energy solid (e.g., a gel, a semi-solid, or a low surface-energy solid with a surface energy density that is similar to that of a liquid).

Elements of embodiments described with respect to a given aspect of the invention may be used in various embodiments of another aspect of the invention. For example, it is contemplated that features of dependent claim depending from one independent claim can be used in apparatus, articles, systems, and/or methods of any of the other independent claims.

### BRIEF DESCRIPTION OF THE DRAWINGS

The objects and features of the invention can be better understood with reference to the drawings described below, and the claims. The drawings are not necessarily to scale, emphasis instead generally being placed upon illustrating the principles of the invention. In the drawings, like numerals are used to indicate like parts throughout the various views.

While the invention is particularly shown and described herein with reference to specific examples and specific embodiments, it should be understood by those skilled in the art that various changes in form and detail may be made therein without departing from the spirit and scope of the invention.

FIG. 1A is a schematic cross-sectional view of a liquid contacting a non-wetting surface, in accordance with certain embodiments of the invention.

FIG. 1B is a schematic cross-sectional view of a liquid that has impaled a non-wetting surface, in accordance with certain embodiments of the invention.

FIG. 1C is a schematic cross-sectional view of a primary liquid in contact with a liquid-impregnated surface, in accordance with certain embodiments of the invention.

FIG. 1D is a regime map showing four different states of a lubricant-impregnated surface with a high surface tension and a low surface tension lubricant, in accordance with certain embodiments of the invention.

FIG. 1E illustrates a schematic diagram of a liquid droplet placed on a textured surface impregnated with a lubricant that wets the solid completely.

FIG. 1F illustrates a schematic diagram of a liquid droplet placed on a textured surface impregnated with a lubricant that wets the solid with a non-zero contact angle in the presence of air and the droplet liquid.

FIG. 1G illustrates a water droplet on a silicon micro post surface (post side a=10 μm, height=10 μm, and spacing b=10 μm) coated with OTS (octadecyltrichlorosilane) and impregnated with silicone oil.

FIG. 1H illustrates a water droplet on a silicon micro post surface (post side a=10 μm, height=10 μm, and spacing b=10 μm) coated with OTS (octadecyltrichlorosilane) and impregnated with 1-butyl-3-methylimidazolium bis(trifluoromethylsulfonyl) imide (BMIm).

FIGS. 1I and 1J illustrate a water droplet under UV illumination when a fluorescent dye was dissolved in silicone oil and BMIm. The bottom regions show that the lubricating oils are pulled up above the texture surface (b=50 m).

FIGS. 1K and 1L show laser confocal fluorescence microscopy (LCFM) images of the impregnated texture showing that post tops were bright in the case of silicone oil (FIG. 1K), suggesting that they were covered with oil, and were dark in the case of BMIm (FIG. 1L), suggesting that they were dry.

FIG. 1M illustrates an ESEM image of the impregnated texture showing the silicone oil trapped in the texture and suggesting that the film that wets the post tops is thin.

FIG. 1N illustrates a SEM image of the texture impregnated with BMIm showing discrete droplets on post tops indicating that a film was not stable in this case.

FIG. 1O illustrates schematics of wetting configurations outside and underneath a drop. The total interface energies per unit area are calculated for each configuration by summing the individual interfacial energy contributions. Equivalent requirements for stability of each configuration are also shown in FIG. 1E.

FIG. 1P illustrates a schematic diagram of possible thermodynamic states of a water droplet placed on a lubricant-encapsulated surface. The top two schematics illustrate whether or not the droplet becomes cloaked by the lubricant. For each case, there are six possible states, as illustrated, depending on how the lubricant wets the texture in the presence of air (the vertical axis) and water (horizontal axis).

FIG. 1Q is a schematic describing six liquid-impregnated surface wetting states, in accordance with certain embodiments of the invention.

FIGS. 2A-2B show a comparison of the calcium sulfate salt formation on (FIG. 2A) smooth silicon and (FIG. 2B) a liquid-impregnated surface, in accordance with certain embodiments of the invention.

FIG. 3 illustrates a schematic cross-sectional and corresponding top view of a liquid-impregnated surface that is partially submerged.

FIG. 4 shows a schematic illustration of the experimental set-up used in the Examples.

FIGS. 5A-5B are SEMs showing results from Example 1, illustrating the effect of the impregnating liquid on scale formation. The figure shows the schematics of the liquid-impregnated surfaces and the images of the two samples (FIG. 5A and FIG. 5B) after scaling experiments performed with different liquids.

FIG. 6 shows two graphs of experimental results showing mass gain on various substrates due to scale formation.

FIG. 7A shows an example experimental set-up used in the Examples in accordance with some embodiments of the invention.

FIG. 7B shows surface coverage of an untreated silicon and silicone oil impregnated silicon at different times.

FIG. 7C shows a series of photographs illustrating scale formation on bare silicon substrate after 33, 53, and 80 hours, respectively. The scale bar in FIG. 7C is 1 mm.

FIG. 7D shows a series of photographs illustrating scale formation on silicone oil-impregnated substrates after 33, 53, and 80 hours, respectively. The scale bar in FIG. 7D is 1 mm. These photographs demonstrate delay in scale incubation time on the liquid-impregnated surface, according to some embodiments of the invention.

FIG. 8A illustrates a schematic of lubricant impregnation in steel, according to some embodiments of the present invention.

FIG. 8B is an SEM image of a sandblasted steel substrate; the scale bar is 50 μm.

FIGS. 8C and 8D are photographs of (C) bare steel and (D) impregnated steel before washing with a steady stream of water at a flow rate of about 150 ml/min for ˜30 seconds. The scale bar is 5 mm.

FIGS. 8E and 8F are SEM images of (E) bare steel and (F) impregnated steel before washing with a steady stream of water at a flow rate of about 150 ml/min for ˜30 seconds. The scale bar is 1 mm.

FIGS. 8G and 8H are photographs of (G) bare steel and (H) impregnated steel after washing with a steady stream of water at a flow rate of about 150 ml/min for ˜30 seconds. The scale bar is 5 mm.

FIGS. 8I and 8J are SEM images of (I) bare steel and (J) impregnated steel after washing with a steady stream of water at a flow rate of about 150 ml/min for ˜30 seconds. The scale bar is 1 mm.

Also shown is a comparison of the scale-inhibiting performance of smooth stainless steel compared with liquid-impregnated stainless steel.

FIG. 9 shows a comparison of the corrosion on two substrates (left) bare carbon steel and (right) liquid impregnated carbon steel, according to an illustrative embodiment of the invention.

FIGS. 10A-10B illustrate schematics of a smooth uncoated silicon substrate and a lubricant-impregnated nano-textured silicon substrate, respectively, according to some embodiments of the invention.

FIGS. 10C-10D illustrate photographs of calcium sulfate (CaSO₄) scale formation after ˜80 hours of residence time on a smooth uncoated silicon substrate and a lubricant-impregnated nano-textured silicon substrate, respectively. The scale bar in FIGS. 10C-10D is 5 mm.

FIGS. 10E-10F illustrate SEM images of CaSO₄ scale formation after ˜80 hours of residence time on a smooth uncoated silicon substrate and a lubricant-impregnated nano-textured silicon substrate, respectively. The scale bar in FIGS. 10E-10F is 1 mm.

### DETAILED DESCRIPTION

It is contemplated that compositions, mixtures, systems, devices, methods, and processes of the claimed invention encompass variations and adaptations developed using information from the embodiments described herein. Adaptation and/or modification of the compositions, mixtures, systems, devices, methods, and processes described herein may be performed by those of ordinary skill in the relevant art.

Throughout the description, where articles, devices and systems are described as having, including, or comprising specific components, or where processes and methods are described as having, including, or comprising specific steps, it is contemplated that, additionally, there are articles, devices, and systems of the present invention that consist essentially of, or consist of, the recited components, and that there are processes and methods according to the present invention that consist essentially of, or consist of, the recited processing steps.

Similarly, where articles, devices, mixtures, and compositions are described as having, including, or comprising specific compounds and/or materials, it is contemplated that, additionally, there are articles, devices, mixtures, and compositions of the present invention that consist essentially of, or consist of, the recited compounds and/or materials.

It should be understood that the order of steps or order for performing certain actions is immaterial so long as the invention remains operable. Moreover, two or more steps or actions may be conducted simultaneously.

The mention herein of any publication, for example, in the Background section, is not an admission that the publication serves as prior art with respect to any of the claims presented herein. The Background section is presented for purposes of clarity and is not meant as a description of prior art with respect to any claim.

Described herein are embodiments and experiments with liquid-impregnated substrates with varying surface energies for which a demonstration of the effect of surface energy on scale formation is performed. Scale formation can be qualitatively (using SEM) and quantitatively (weight gain) observed at various residence times, in contact with a mineral solution.

Without wishing to be bound by any theory, it is believed that salt particles nucleate on surfaces at a rate given by

$$J = N {β}^{*} {exp}^{- \frac{Δ {G}^{*}}{{k}_{B} T}} \qquad ( 1 )$$

The activation barrier (ΔG*) required for this nucleation dictates the rate at which the salt nucleates. Another factor that plays a role in determining the rate of nucleation is the number of potential nucleation sites (N) available for these salt particles. Without wishing to be bound by a particular theory, an extremely smooth surface with a very low surface energy would be a preferable surface to combat scaling problems. Mechanical damage may lead to increased roughness thereby reducing the effectiveness of these surfaces.

The precipitation of scale is believed to follow the nucleation-growth mechanism. The steady-state nucleation rate J at a temperature T is given by the classical nucleation theory Equation (2) below

$$J = NZ {β}^{*} {exp}^{- \frac{Δ {G}^{*}}{{k}_{B} T}} \qquad ( 2 )$$

where N is the density of nucleation sites, β* is the atomic attachment rate, Z is the Zeldovich's factor, and (ΔG*) is the activation barrier for nucleation. The density of nucleation sites N, depends on the roughness and heterogeneity of the surface, with a smoother surface corresponding to a lower nucleation site density and hence lower nucleation rate. The activation barrier for nucleation, ΔG*, depends on the surface properties and is given by the Equation (3) below

$$Δ {G}^{*} = \frac{{πσ}_{cw} {r}^{* 2}}{3} ( 2 - 3 m + {m}^{3} ) \qquad ( 3 )$$

where σ_{cw} is the salt nucleus (c)—salt solution (w) interfacial energy, r* is the critical size of the nucleus, m is the ratio of the interfacial energies given by Equation (4) below:

$$m = \frac{{σ}_{sw} - {σ}_{cs}}{{σ}_{cw}} \qquad ( 4 )$$

where σ_{sw} and σ_{cs} are the interfacial energies of [the substrate (s)—salt solution (w)] and [the substrate (s)—salt nucleus (c) interfaces], respectively. The activation barrier ΔG* is high on low energy surfaces. In some embodiments, a smooth, low energy surface is ideal to combat scale problems.

The thermodynamic state of a lubricant-impregnated surface depends on the choice of the lubricant and the geometry of the underlying texture. Having a stable impregnated state is important to avoid the displacement of the lubricant by the salt solution. The value of Θ_{c} is calculated using the Equation (5) below:

$${Θ}_{c} = {cos}^{- 1} ( \frac{1 - φ}{r - φ} ) \qquad ( 5 )$$

In Eq. (5), ϕ is the solid fraction of the projected area of a textured surface and r is the roughness of the substrate given by the ratio of the total surface area to the projected surface area. An extremely rough textured solid (e.g., large r) is preferred in some embodiments as the underlying substrate for lubricant-impregnated surface to maintain a stable impregnating state.

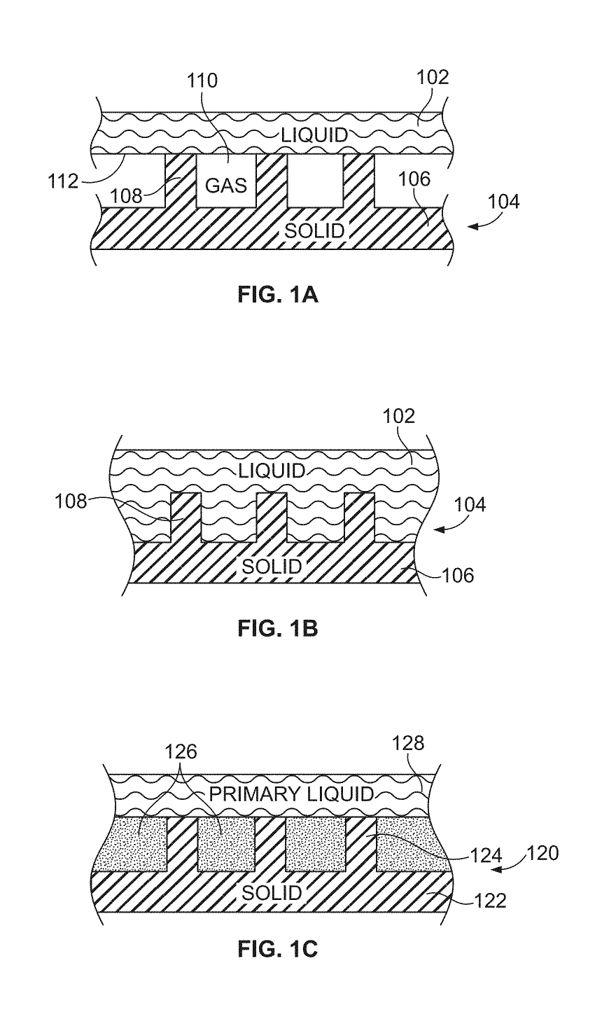

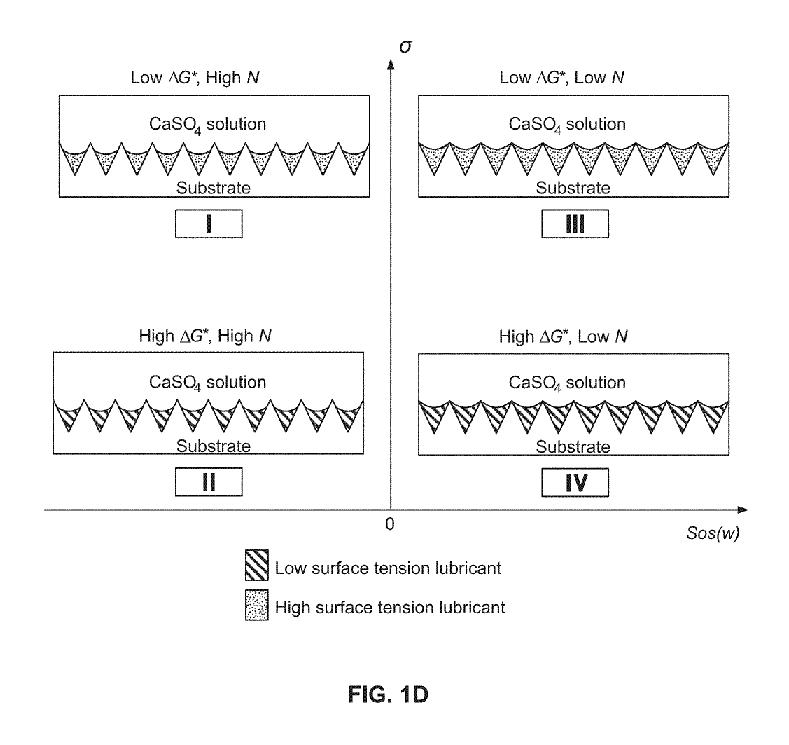

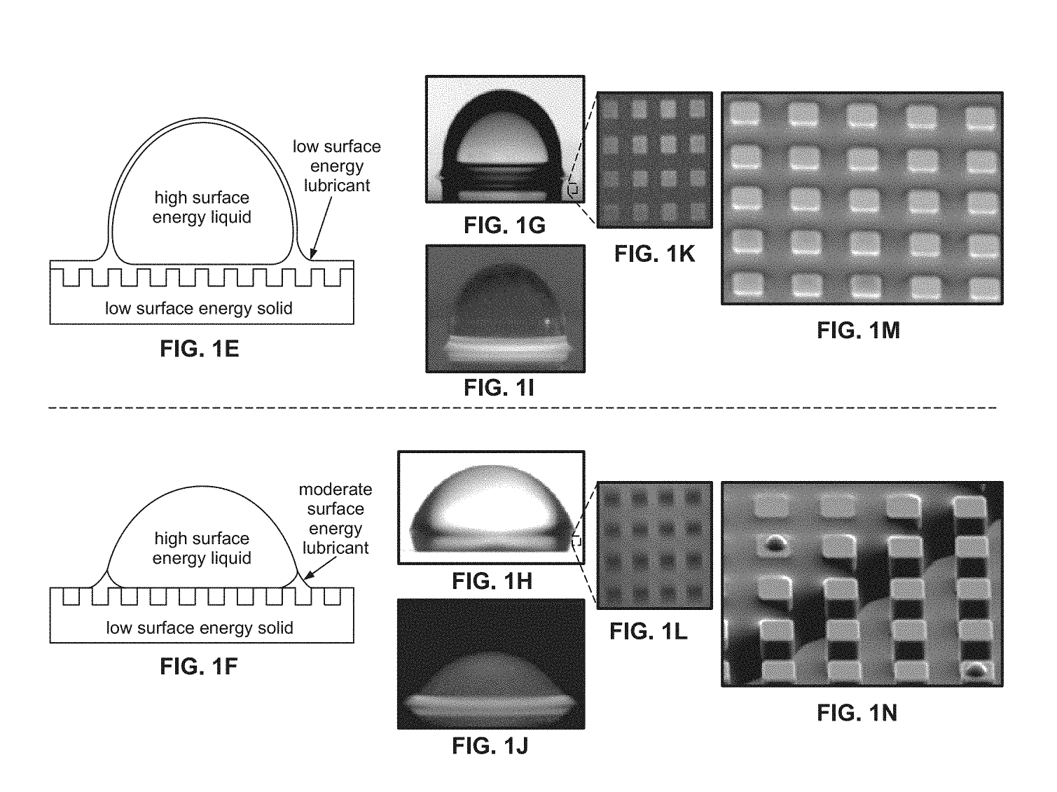

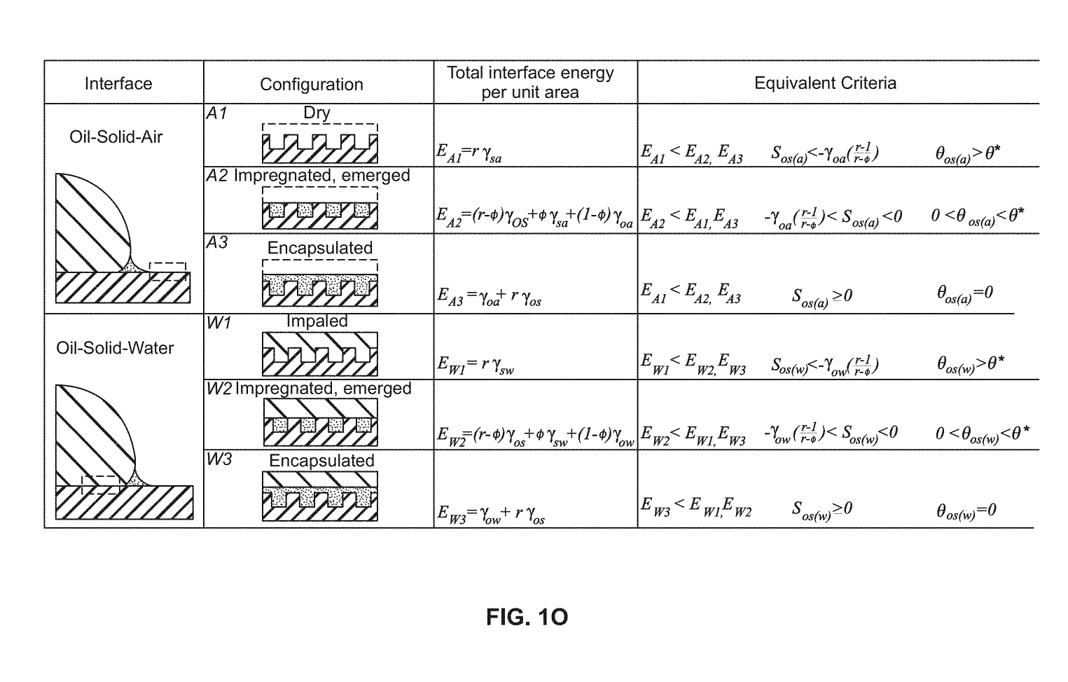

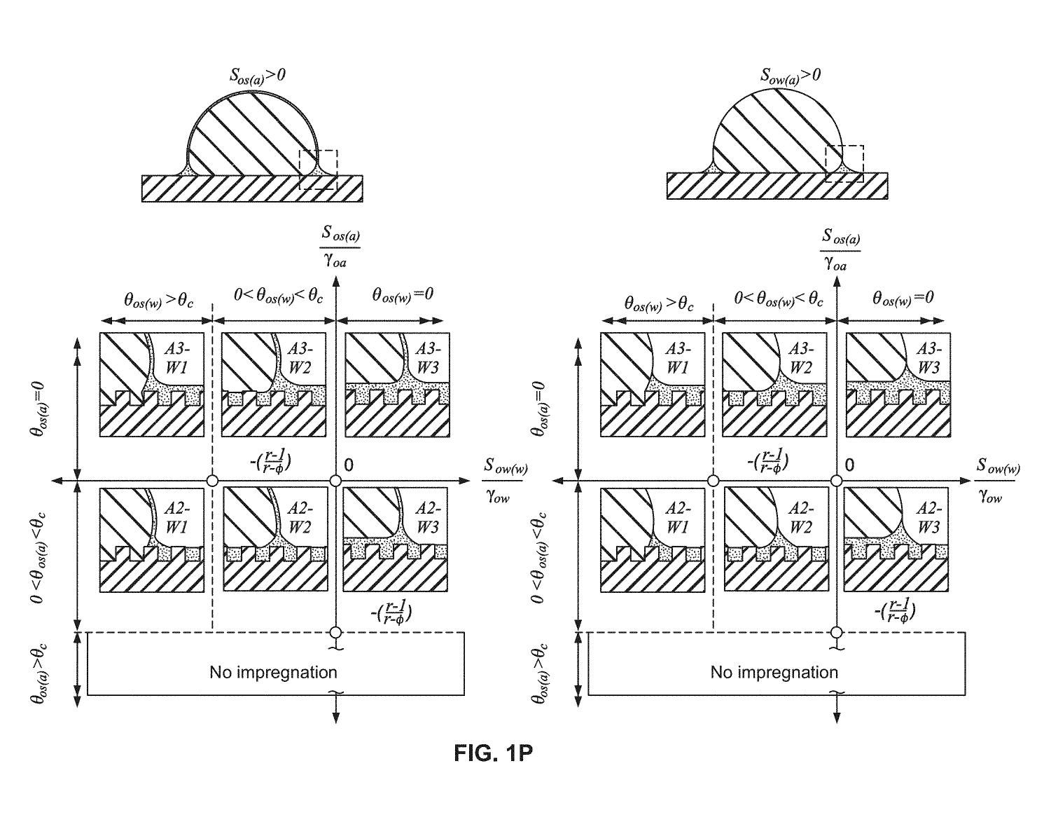

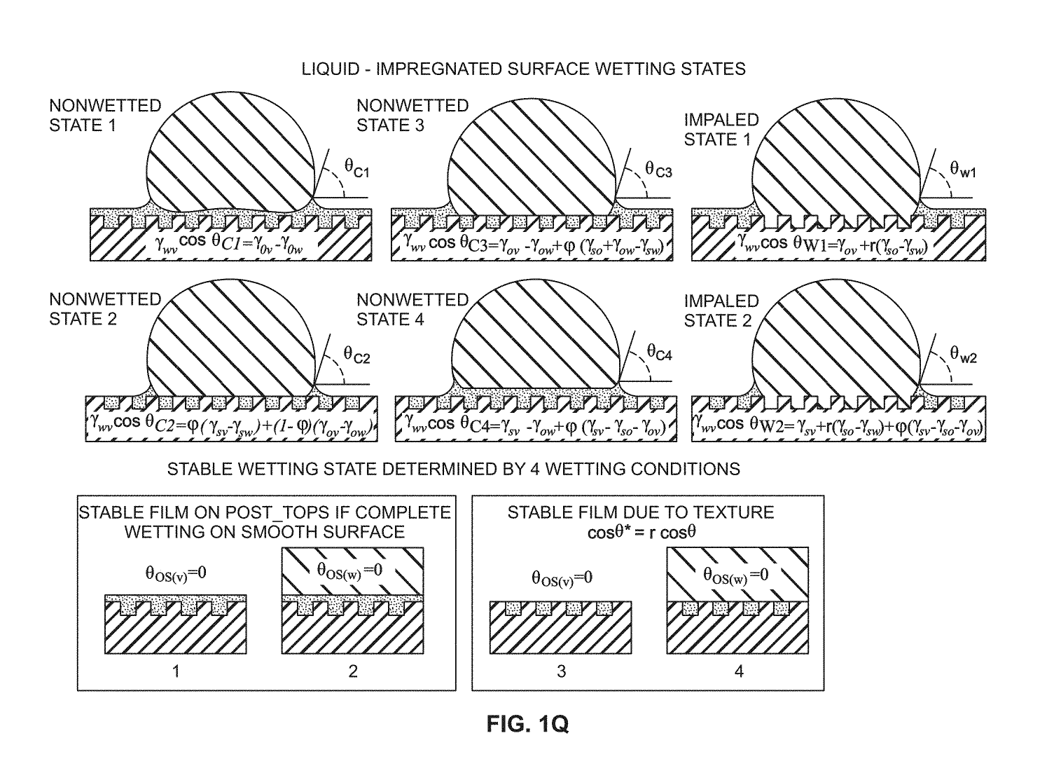

FIG. 1d illustrates a regime map of the stable states of lubricant-impregnated surface immersed in salt solution. Four different states (I, II, III, and IV) are possible based on the properties of the impregnating lubricant-surface tension (σ) and the spreading coefficient (S_{os(w)}). The spreading coefficient of the lubricant (subscript ‘o’) on the substrate (subscript ‘s’) in the presence of the salt solution (subscript ‘w’) is given by Equation (6) below:

S_{os(w)}=σ_{sw}−σₒₛ−σ_{ow} (6)

where σ_{sw}, σₒₛ, and σ_{ow} are the interfacial energies of substrate-salt solution, lubricant-substrate, and lubricant-salt solution, respectively.

Depending on the surface tension of the lubricant, the substrate can effectively have a high-energy surface (states I and III in FIG. 1d) or a low-energy surface (states II and IV in FIG. 1d). This factor influences the activation barrier for nucleation on the lubricant-impregnated surface: an impregnating lubricant with a low surface tension results in a high activation barrier (ΔG*) for nucleation on the surface and vice versa.

Furthermore, the impregnating lubricant controls the density of nucleation sites (N) depending on its spreading coefficient on the surface in the presence of salt solution: an impregnating lubricant with a positive spreading coefficient submerges the entire texture (states III and IV in FIG. 1d), while a lubricant with a negative spreading coefficient would result in the tops of the texture being exposed to the salt solution (states I and II in FIG. 1d). An impregnated surface with submerged texture has a much lower density of nucleation sites (N) compared to an impregnated surface with the texture tops exposed to the salt solution. Thus, with an optimized design of the lubricant (which in some embodiments refers to low N and high (ΔG*), the lubricant-impregnated surface can satisfy the criteria for effective scale-resistant surfaces (state IV in FIG. 1d).

It is found herein that liquid-impregnated surfaces that combine the properties of low surface energy and high degree of smoothness along with high resistance to mechanical damage because of the self-healing property of these surfaces exhibit desirable scale resistance properties.

Liquid impregnated interfaces may include a low surface energy textured solid for capillary stabilization and a suitable impregnating liquid having a low polar component of surface energy. In some embodiments, the impregnating liquid submerges the entire texture. In some embodiments, the impregnating liquid only partially submerges the texture.

In some embodiments of liquid-impregnated surfaces described herein, emerged area fraction ϕ is less than 0.30, 0.25, 0.20, 0.15, 0.10, 0.05, 0.01, or 0.005. In some embodiments, ϕ is greater than 0.001, 0.005, 0.01, 0.05, 0.10, 0.15, or 0.20. In some embodiments, ϕ is in a range of about 0 and about 0.25. In some embodiments, ϕ is in a range of about 0 and about 0.01. In some embodiments, ϕ is in a range of about 0.001 and about 0.25. In some embodiments, ϕ is in a range of about 0.001 and about 0.10.

In some embodiments, the liquid-impregnated surface is configured such that cloaking by the impregnating liquid can be either eliminated or induced, according to different embodiments described herein.

As used herein, the spreading coefficient, S_{ow(a)} is defined as γ_{wa}−γ_{wo}−γₒₐ, where γ is the interfacial tension between the two phases designated by subscripts w, a, and o, where w is water, a is air, and o is the impregnating liquid. Interfacial tension can be measured using a pendant drop method as described in Stauffer, C. E., “The measurement of surface tension by the pendant drop technique,” J. Phys. Chem. 1965, 69, 1933-1938, the text of which is incorporated by reference herein. Exemplary surfaces and its interfacial tension measurements (at approximately 25° C.) are Table 3 below.

Without wishing to be bound to any particular theory, impregnating liquids that have S_{ow(a)} less than 0 will not cloak matter as seen in FIG. 1g, resulting in no loss of impregnating liquids, whereas impregnating liquids that have S_{ow(a)} greater than 0 will cloak matter (condensed water droplets, bacterial colonies, solid surface) as seen in FIG. 1f and this may be exploited to prevent corrosion, fouling, etc. In certain embodiments, cloaking is used for preventing vapor-liquid transformation (e.g., water vapor, metallic vapor, etc.). In certain embodiments, cloaking is used for inhibiting liquid-solid formation (e.g., ice, metal, etc.). In certain embodiments, cloaking is used to make reservoirs for carrying the materials, such that independent cloaked materials can be controlled and directed by external means (like electric or magnetic fields).

FIG. 1g illustrates a water droplet on a silicon micro post surface (post side a=10 μm, height=10 μm, and spacing b=10 m) coated with OTS (octadecyltrichlorosilane) and impregnated with silicone oil. FIG. 1h illustrates a water droplet on a silicon micro post surface (post side a=10 μm, height=10 μm, and spacing b=10 m) coated with OTS (octadecyltrichlorosilane) and impregnated with 1-butyl-3-methylimidazolium bis(trifluoromethylsulfonyl)imide (BMIm). FIGS. 1i and 1j illustrate a water droplet under UV illumination when a fluorescent dye was dissolved in silicone oil and BMIm. The bottom regions show that the lubricating oils are pulled up above the texture surface (b=50 μm).

FIG. 1g shows an 8 μl water droplet placed on the silicone oil impregnated texture. The droplet forms a large apparent contact angle (˜100°) but very close to the solid surface (shown by arrows in FIG. 1g), its profile changes from convex to concave.

When a fluorescent dye was added to the silicone oil and imaged under UV light, the point of inflection corresponded to the height to which an annular ridge of oil was pulled up in order to satisfy a vertical force balance of the interfacial tensions at the inflection point (FIG. 1i). Although the oil should spread over the entire droplet (FIG. 1g), the cloaking film was too thin to be captured in these images. The “wetting ridge” was also observed in the case of ionic liquid (FIGS. 1h, 1j). The importance of the wetting ridge to droplet mobility will be discussed below. Such wetting ridges are reminiscent of those observed around droplets on soft substrates.

The texture can be completely submerged in the oil if θₒₛ₍ₐ₎=0°. This condition was found to be true for silicone oil, implying that the tops of the posts should be covered by a stable thin oil film. This film was observed experimentally using laser confocal fluorescence microscopy (LCFM); the post tops appear bright due to the presence of a fluorescent dye that was dissolved in the oil (FIG. 1k). Environmental SEM images of the surface (FIG. 1m) show the oil-filled texture and confirm that this film is less than a few microns thick, consistent with prior estimates of completely-wetting films. On the other hand, BMIm has a non-zero contact angle on a smooth OTS-coated silicon surface (θ_{os (a)}=65±5°) indicating that with this lubricant the post tops should remain dry. Indeed, LCFM images confirmed this (FIG. 1 (h))—the post tops appear dark as there is no dye present to fluoresce. Since BMIm is conductive and has an extremely low vapor pressure, it could be imaged in a SEM. As shown in FIG. 1n, discrete droplets resting on post tops are seen, confirming that a thin film was not stable on the post tops in this case.

The stable wetting configuration affects the mobility of droplets. As shown in FIG. 1f, in the case of BMIm, there are three distinct phase contact lines at the perimeter of the drop that confine the wetting ridge: the oil-water-air contact line, the oil-solid-air contact line outside the drop, and the oil-solid-water contact line underneath the drop. These contact lines exist because θₒₛ₍ₐ₎>0, θ_{os(w)}>0, and S_{ow(a)}<0. In contrast, in the case of silicone oil (FIG. 1e), none of these contact lines exist because θₒₛ₍ₐ₎=0, θ_{os(w)}=0, and S_{ow(a)}>0. These configurations are just two of the 12 different configurations in such a four-phase system where oil impregnation is possible. These configurations are discussed below.

A thermodynamic framework that allows one to predict which of these 12 states will be stable for a given droplet, oil, and substrate material will be discussed in the paragraphs below. There are three possible configurations to consider for the interface outside of the droplet (in an air environment), and three possible configurations to consider for the interface underneath the droplet (in a water environment). These configurations are shown in FIG. 1o along with the total interface energy of each configuration. The configurations possible outside the droplet are A1 (not impregnated, i.e., dry), A2 (impregnated with emergent features), and A3 (impregnated with submerged features—i.e., encapsulated). On the other hand, underneath the droplet, the possible configurations are W1 (impaled), W2 (impregnated with emergent features), and W3 (impregnated with submerged features—i.e., encapsulated). The stable configuration will be the one that has the lowest total interface energy. Referring now to configurations outside the droplet, the textured surface as it is slowly withdrawn from a reservoir of oil could be in any of states A1, A2, and A3 depending on which has the lowest energy. For example, state A2 would be stable if it has the lowest total interface energy, i.e. E_{A2}<E_{A1}, E_{A3}. From FIG. 1o, this results in:

E_{A2}<E_{A1}↔(γₛₐ−γₒₛ)/γₒₐ>(1−ϕ)/(r−ϕ) (7)

E_{A2}<E_{A3}↔γₛₐ−γₒₛ−γₒₐ<0 (8)

where ϕ is the fraction of the projected area of the surface that is occupied by the solid and r is the ratio of total surface area to the projected area of the solid. In the case of square posts with width “a”, edge-to-edge spacing “b”, and height “h”, ϕ=a²/(a+b)² and r=1+4 ah/(a+b)². Applying Young's equation, cos(θos(a))=(γₛₐ−γₒₛ)/γₒₐ, Eq. (7) reduces to the hemi-wicking criterion for the propagation of oil through a textured surface: cos(θₒₛ₍ₐ₎)>(1−ϕ)/(r−ϕ)=cos(θ_{c}). This requirement can be conveniently expressed θₒₛ₍ₐ₎<θ_{c}. In Eq. (8), γₛₐ−γₒₛ−γₒₐ, is simply the spreading coefficient Sₒₛ₍ₐ₎ of oil on the textured surface in the presence of air. This may be reorganized as (γₛₐ−γₒₛ)/γₒₐ<1, and applying Young's equation again, Eq. (8) can be written as θₒₛ₍ₐ₎>0. Expressing Eq. (7) in terms of the spreading coefficient Sₒₛ₍ₐ₎, yields: −γₒₐ(r−1)/(r−ϕ)<Sₒₛ₍ₐ₎. The above simplifications then lead to the following equivalent criteria for the surface to be in state A2:

E_{A2}<E_{A1},E_{A3}↔θ_{c}>θₒₛ₍ₐ₎>0↔−γₒₐ(r−1)/(r−ϕ)<Sₒₛ₍ₐ₎<0 (9)

Similarly, state A3 would be stable if E_{A3}<E_{A2}, E_{A1}. From FIG. 1o, this gives:

E_{A3}<E_{A2}↔θₒₛ₍ₐ₎=0↔γₛₐ−γₒₛ−γₒₐ≡Sₒₛ₍ₐ₎≥0 (10)

E_{A3}<E_{A1}↔θₒₛ₍ₐ₎<cos⁻¹(1/r)↔Sₒₛ₍ₐ₎>−γₒₐ(1/1/r) (11)

Note that Eq. (11) is automatically satisfied by Eq. (10), thus the criterion for state A3 to be stable (i.e., encapsulation) is given by Eq. (10). Following a similar procedure, the condition for state A1 to be stable can be derived as

E_{A1}<E_{A2},E_{A3}↔θₒₛ₍ₐ₎>θ_{c}↔Sₒₛ₍ₐ₎<−γₒₐ(r−1)/(r−ϕ) (12)

The rightmost expression of Eq. (10) can be rewritten as (γₛₐ−γₒₛ)/γₒₐ≥1. This raises an important point: Young's equation would suggest that if θ_{os (a)}=0, then (γₛₐ−γₒₛ)/γₒₐ=1 (i.e., Sₒₛ₍ₐ₎=0). However, θₒₛ₍ₐ₎=0 is true also for the case that (γₛₐ−γₒₛ)/γₒₐ>1 (i.e. Sₒₛ₍ₐ₎>0). It is important to realize that Young's equation predicts the contact angle based on balancing the surface tension forces on a contact line—the equality only exists for a contact line at static equilibrium. For a spreading film (Sₒₛ₍ₐ₎>0) a static contact line doesn't exist, hence precluding the applicability of Young's equation.

The configurations possible underneath the droplet are discussed in the paragraphs below. Upon contact with water, the interface beneath the droplet will attain one of the three different states—W1, W2, or W3 (FIG. 1o)—depending on which has the lowest energy. Applying the same method to determine the stable configurations of the interface beneath the droplet, and using the total interface energies provided in Table 1, the stability requirements take a form similar to Eqs. (9), (10), and (12), with γₒₐ, γₛₐ, θₒₛ₍ₐ₎, Sₒₛ₍ₐ₎, replaced with γ_{ow}, γ_{sw}, θ_{os(w)}, S_{os(w)}, respectively. In some embodiments, θ_{c} is not affected by the surrounding environment as it is only a function of the texture parameters, (p and r. Thus, the texture will remain impregnated with oil beneath the droplet with emergent post tops (i.e., state W2) when:

E_{W2}<E_{W1},E_{W3}↔θ_{c}>θ_{os(w)}>0↔−γ_{ow}(r−1)/(r−ϕ)<S_{os(w)}<0 (13)

State W3 will be stable (i.e., the oil will encapsulate the texture) when:

E_{W3}<E_{W1},E_{W2}↔θ_{os(w)}=0↔γ_{sw}−γₒₛ−γ_{ow}≡S_{os(w)}≥0 (14)

and the droplet will displace the oil and be impaled by the textures (state W1) when:

E_{W1}<E_{W2},E_{W3}↔θ_{os(w)}>θ_{c}↔S_{os(w)}<−γ_{ow}(r−1)/(r−ϕ) (15)

Combining the above criteria along with the criterion for cloaking of the water droplet by the oil film, the various possible states can be organized in a regime map, which is shown FIG. 1p. The cloaking criterion is represented by the upper two schematic drawings. For each of these cases, there are six different configurations possible depending on how the oil interacts with the surface texture in the presence of air (vertical axis in FIG. 1p) and water (horizontal axis in FIG. 1p). The vertical and horizontal axes are the normalized spreading coefficients Sₒₛ₍ₐ₎/γₒₐ and S_{os(w)}/γ_{ow} respectively. Considering first the vertical axis of FIG. 1p, when Sₒₛ₍ₐ₎/γₒₐ<−(r−1)/(r−ϕ), i.e., when Eq. (12) holds, oil does not even impregnate the texture. As Sₒₛ₍ₐ₎/γₒₐ increases above this important value, impregnation becomes feasible but the post tops are still left emerged. Once Sₒₛ₍ₐ₎/γₒₐ>0, the post tops are also submerged in the oil leading to complete encapsulation of the texture. Similarly, on the x-axis of FIG. 1p moving from left to right, as S_{os(w)}/γ_{ow} increases, the droplet transitions from an impaled state to an impregnated state to a fully-encapsulated state. Although prior studies have proposed simple criteria for whether a deposited drop would float or sink, additional states, as shown in FIG. 1p, were not recognized.

FIG. 1p shows that there can be up to three different contact lines, two of which can get pinned on the texture. The degree of pinning determines the roll-off angle α*, the angle of inclination at which a droplet placed on the textured solid begins to move. Droplets that completely displace the oil (states A3-W1, A2-W1 in FIG. 1p) are not expected to roll off the surface. These states are achieved when θ_{os(w)}>θ_{c}, as is the case for both BMIm and silicone oil impregnated surfaces when the silicon substrates are not treated with OTS. As expected, droplets did not roll off of these surfaces. Droplets in states with emergent post tops (A3-W2, A2-W2, A2-W3) are expected to have reduced mobility that is strongly texture dependent, whereas those in states with encapsulated posts outside and beneath the droplet (the A3-W3 states in FIG. 1p) are expected to exhibit no pinning and consequently infinitesimally small roll-off angles.

Droplets placed on lubricant-impregnated surfaces exhibit fundamentally different behavior compared to typical superhydrophobic surfaces. In some embodiments, these four-phase systems can have up to three different three-phase contact lines, giving up to twelve different thermodynamic configurations. In some embodiments, the lubricant film encapsulating the texture is stable only if it wets the texture completely (θ=0), otherwise portions of the textures dewet and emerge from the lubricant film. In some embodiments, complete encapsulation of the texture is desirable in order to eliminate pinning. In some embodiments, texture geometry and hierarchical features can be exploited to reduce the emergent areas and achieve roll-off angles close to those obtained with fully wetting lubricants. In some embodiments, droplets of low-viscosity liquids, such as water placed on these impregnated surfaces, roll rather than slip with velocities that vary inversely with lubricant viscosity. In some embodiments, additional parameters, such as droplet and texture size, as well as the substrate tilt angle, may be modeled to achieve desired droplet (and/or other substance) movement (e.g., rolling) properties and/or to deliver optimal non-wetting properties.

FIG. 1q is a schematic describing six liquid-impregnated surface wetting states, in accordance with certain embodiments described herein. The six surface wetting states (state 1 through state 6) depend on the four wetting conditions shown at the bottom of FIG. 1q (conditions 1 to 4). In some embodiments, the non-wetted states are preferred (states 1 to 4). Additionally, where a thin film stably forms on the tops of the posts (or other features on the surface), as in non-wetted states 1 and 3, even more preferable non-wetting properties (and other related properties described herein) may be observed.

In order to achieve non-wetted states, it is often preferable to have low solid surface energy and low surface energy of the impregnated liquid compared to the nonwetted liquid. For example, surface energies below about 25 mJ/m² are desired in some embodiments. Low surface energy liquids include certain hydrocarbon and fluorocarbon-based liquids, for example, silicone oil, perfluorocarbon liquids, perfluorinated vaccum oils (e.g., Krytox 1506 or Fromblin 06/6), fluorinated coolants such as perfluoro-tripentylamine (e.g., FC-70, sold by 3M, or FC-43), fluorinated ionic liquids that are immiscible with water, silicone oils comprising PDMS, and fluorinated silicone oils.

Examples of low surface energy solids include the following: silanes terminating in a hydrocarbon chain (such as octadecyltrichlorosilane), silanes terminating in a fluorocarbon chain (e.g., fluorosilane), thiols terminating in a hydrocarbon chain (such butanethiol), and thiols terminating in a fluorocarbon chain (e.g. perfluorodecane thiol). In certain embodiments, the surface includes a low surface energy solid such as a fluoropolymer, for example, a silsesquioxane such as fluorodecyl polyhedral oligomeric silsesquioxane. In certain embodiments, the fluoropolymer is (or includes) tetrafluoroethylene (ETFE), fluorinated ethylenepropylene copolymer (FEP), polyvinylidene fluoride (PVDF), perfluoroalkoxytetrafluoroethylene copolymer (PFA), polytetrafluoroethylene (PTFE), tetrafluoroethylene, perfluoromethylvinylether copolymer (MFA), ethylenechlorotrifluoroethylene copolymer (ECTFE), ethylene-tetrafluoroethylene copolymer (ETFE), perfluoropolyether, and/or Tecnoflon.

In certain embodiments, an impregnating liquid is or includes an ionic liquid. Ionic liquids have extremely low vapor pressures (˜10⁻¹² mmHg), and therefore they mitigate the concern of the lubricant loss through evaporation. In some embodiments, an impregnating liquid can be selected to have a S_{ow(a)} less than 0. Exemplary impregnating liquids include, but are not limited to, tetrachloroethylene (perchloroethylene), phenyl isothiocyanate (phenyl mustard oil), bromobenzene, iodobenzene, o-bromotoluene, alpha-chloronaphthalene, alpha-bromonaphthalene, acetylene tetrabromide, 1-butyl-3-methylimidazolium bis(trifluoromethylsulfonyl) imide (BMIm), tribromohydrin (1,2,3-tribromopropane), tetradecane, cyclohexane, ethylene dibromide, carbon disulfide, bromoform, methylene iodide (diiodomethane), stanolax, Squibb's liquid petrolatum, p-bromotoluene, monobromobenzene, perchloroethylene, carbon disulfide, phenyl mustard oil, monoiodobenzene, alpha-monochloro-naphthalene, acetylene tetrabromide, aniline, butyl alcohol, isoamyl alcohol, n-heptyl alcohol, cresol, oleic acid, linoleic acid, amyl phthalate and any combination thereof.

In accordance with some embodiments of the present invention, exemplary solid features include, but are not limited to, polymeric solid, a ceramic solid, a fluorinated solid, an intermetallic solid, and a composite solid and any combination thereof. As demonstrated in FIG. 3, solid features can include any suitable shapes and/or define any suitable structures. Exemplary solid features include, but are not limited to, pores, cavities, wells, interconnected pores, and interconnected cavities and any combination thereof.

In some embodiments, solid features have a roughened surface. As used herein, θₒₛ₍ₐ₎ is defined as the contact angle of oil (subscript ‘o’) on the textured solid (subscript ‘s’) in the presence of air (subscript ‘a’). In certain embodiments, the roughened surface of solid features provides stable impregnation of liquid therebetween or therewithin, when θₒₛ₍ᵥ₎>θ_{c}.

In certain embodiments, liquid-impregnated surfaces described herein have advantageous droplet roll-off properties that minimize the accumulation of the contacting liquid on the surfaces. Without being bound to any particular theory, a roll-off angle α of the liquid-impregnated surface in certain embodiments is less than 50°, less than 40°, less than 30°, less than 25°, or less than 20°.

According to some embodiments of the present invention, an article includes an interior surface, which is at least partially enclosed (e.g., the article is an oil pipeline, other pipeline, consumer product container, other container) and adapted for containing or transferring a fluid of viscosity, wherein the interior surface comprises a liquid-impregnated surface, said liquid-impregnated surface comprising an impregnating liquid and a matrix of solid features spaced sufficiently close to stably contain the impregnating liquid therebetween or therewithin, wherein the impregnating liquid comprises water (having viscosity 2). In certain embodiments, μ1/μ2 is greater than about 1, about 0.5, or about 0.1.

In certain embodiments, the impregnating liquid comprises an additive to prevent or reduce evaporation of the impregnating liquid. In some embodiments, the additive is a surfactant. Exemplary surfactants include, but are not limited to, docosanoic acid, trans-13-docosenoic acid, cis-13-docosenoic acid, nonylphenoxy tri(ethyleneoxy) ethanol, methyl 12-hydroxyoctadecanate, 1-Tetracosanol, fluorochemical “L-1006”, and any combination thereof. More details can be found in White, Ian. “Effect of Surfactants on the Evaporation of Water Close to 100 C.” Industrial & Engineering Chemistry Fundamentals 15.1 (1976): 53-59, the contents of which are incorporated herein by references. In addition or in alternative, exemplary additives can include C₁₆H₃₃COOH, C₁₇H₃₃COOH, C₁₈H₃₃COOH, C₁₉H₃₃COOH, C₁₄H₂₉OH, C₁₆H₃₃OH, C₁₈H₃₃OH, C₂₀H₄₁ₙH, C₂₂H₄₅OH, C₁₇H₃₅COOCH₃, C₁₅H₃₁COOC₂H₅, C₁₆H₃₃OC₂H₄OH, C₁₈H₃₇OC₂H₄OH, C₂₀H₄₁ₙC₂H₄OH, C₂₂H₄₅OC₂H₄OH, Sodium docosyl sulfate, poly(vinyl stearae), Poly (octadecyl acrylate), Poly(octadecyl meethacrylate) and any combination thereof. More details can be found in Barnes, Geoff T. “The potential for monolayers to reduce the evaporation of water from large water storages.” Agricultural Water Management 95.4 (2008): 339-353, the contents of which are incorporated herein by reference.

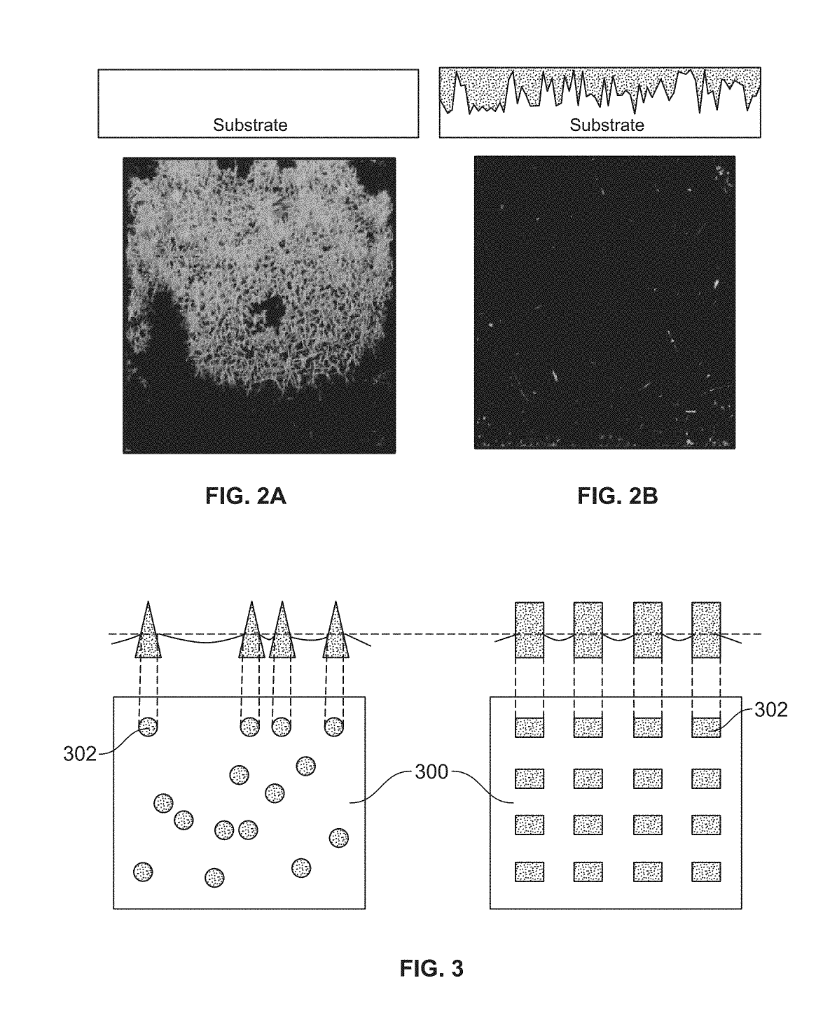

In accordance with various embodiments, it is discovered that scale formation may be reduced by reducing the surface energy of the underlying liquid-impregnated surface. For example, a smooth silicon substrate was compared with a liquid-impregnated surface with regard to the calcium sulfate formation thereupon. FIG. 2 includes photographs of scale formation on these two substrates. The results demonstrate that scale formation was significantly reduced on a liquid-impregnated surface, and details are described in the Experiments below.

Scale-phobic surfaces are generally described in U.S. patent application Ser. No. 13/679,729, titled “Articles and Methods Providing Scale-Phobic Surfaces”, filed Nov. 16, 2012, the disclosure of which is hereby incorporated by reference herein in its entirety. Also, the use of non-wetting surfaces and, more particularly, of surfaces comprising a rare-earth oxide ceramic and encapsulated with a liquid is described in U.S. patent application Ser. No. 13/741,898, filed Jan. 15, 2013, titled “Liquid-Encapsulated Rare-Earth Based Ceramic Surfaces”, the disclosure of which is hereby incorporated by reference herein in its entirety. Features of the articles and surfaces described in these patent applications may be applied in various combinations in the various embodiments described herein.

FIG. 1a is a schematic cross-sectional view of a contacting liquid 102 in contact with a traditional or previous non-wetting surface 104 (i.e., a gas impregnating surface), in accordance with one embodiment of the invention. The surface 104 includes a solid 106 having a surface texture defined by posts 108. The regions between the posts 108 are occupied by a gas 110, such as air. As depicted, while the contacting liquid 102 is able to contact the tops of the posts 108, a gas-liquid interface 112 prevents the liquid 102 from wetting the entire surface 104.

Referring to FIG. 1b, in certain instances, the contacting liquid 102 may displace the impregnating gas and become impaled within the posts 108 of the solid 106. Impalement may occur, for example, when a liquid droplet impinges the surface 104 at high velocity. When impalement occurs, the gas occupying the regions between the posts 108 is replaced with the contacting liquid 102, either partially or completely, and the surface 104 may lose its non-wetting capabilities.

Referring to FIG. 1c, in certain embodiments, a non-wetting, liquid-impregnated surface 120 is provided that includes a solid 122, e.g., a solid having textures (e.g., posts 124) that are impregnated with an impregnating liquid 126, rather than a gas. In the depicted embodiment, a contacting liquid 128 in contact with the surface, rests on the posts 124 (or other texture) of the surface 120. In the regions between the posts 124, the contacting liquid 128 is supported by the impregnating liquid 126. In certain embodiments, the contacting liquid 128 is immiscible with the impregnating liquid 126. For example, the contacting liquid 128 may be water and the impregnating liquid 126 may be oil.

In accordance with various embodiments, it is presently recognized that surface energy of a surface can be reduced by modifying a surface to be impregnated with a liquid with a low surface energy. In some embodiments, the present invention is particularly useful for a metal surface. The metal surface may include aluminum, steel (stainless or carbon steel), copper, titanium, tin, or any combinations thereof.

In some embodiments, the surface includes (e.g., has a solid coating comprising) a fluoropolymer. The fluoropolymer may be, for example, a silsesquioxane, such as fluorodecyl polyhedral oligomeric silsesquioxane. In certain embodiments, the fluoropolymer includes tetrafluoroethylene (ETFE), fluorinated ethylene-propylene copolymer (FEP), polyvinylidene fluoride (PVDF), perfluoroalkoxy-tetrafluoroethylene copolymer (PFA), polytetrafluoroethylene (PTFE), tetrafluoroethylene perfluoromethylvinylether copolymer (MFA), ethylene-chlorotrifluoroethylene copolymer (ECTFE), ethylene-tetrafluoroethylene copolymer (ETFE), perfluoropolyether, and/or Tecnoflon, or any combination thereof.

In some embodiments, the surface includes a silane coating. In certain embodiments, the silane coating is a member selected from the group consisting of methylsilane, phenylsilane, isobutylsilane, dimethylsilane, tetramethyldisilane, hexylsilane, octadecylsilane, fluorosilane, and any combination thereof.

The solid 122 can include the same or a different material of an underlying layer. In some embodiments, the solid 122 may include any intrinsically hydrophobic, oleophobic, and/or metallophobic material. For example, the solid 122 may include: hydrocarbons, such as alkanes, and fluoropolymers, such as teflon, trichloro(1H,1H,2H,2H-perfluorooctyl)silane (TCS), octadecyltrichlorosilane (OTS), heptadecafluoro-1,1,2,2-tetrahydrodecyltrichlorosilane, fluoroPOSS, and/or other fluoropolymers. Additional possible materials or coatings for the solid 122 include: ceramics, polymeric materials, fluorinated materials, intermetallic compounds, and composite materials. Polymeric materials may include, for example, polytetrafluoroethylene, fluoroacrylate, fluoroeurathane, fluorosilicone, fluorosilane, modified carbonate, chlorosilanes, silicone, polydimethylsiloxane (PDMS), and/or combinations thereof. Ceramics may include, for example, titanium carbide, titanium nitride, chromium nitride, boron nitride, chromium carbide, molybdenum carbide, titanium carbonitride, electroless nickel, zirconium nitride, fluorinated silicon dioxide, titanium dioxide, tantalum oxide, tantalum nitride, diamond-like carbon, fluorinated diamond-like carbon, and/or combinations thereof. Intermetallic compounds may include, for example, nickel aluminide, titanium aluminide, and/or combinations thereof.

The textures within the liquid-impregnated surface 120 are physical textures or surface roughness. The textures may be random, including fractal, or patterned textures. In certain embodiments, the textures include micro-scale and/or nano-scale features. For example, the textures may have a length scale L (e.g., an average pore diameter, or an average protrusion height) that is less than about 100 microns, less than about 10 microns, less than about 1 micron, less than about 0.1 microns, or less than about 0.01 microns. In certain embodiments, the texture includes posts 124 or other protrusions, such as spherical or hemispherical protrusions. Rounded protrusions may be preferable to avoid sharp solid edges and minimize pinning of liquid edges. The texture (e.g., solid features/protrusions) may be introduced to the surface using any conventional method, including mechanical and/or chemical methods such as lithography, self-assembly, and deposition, for example.

The impregnating liquid 126 may be any type of liquid that is capable of providing the desired low surface energy. For example, the impregnating liquid 126 may be oil-based or water-based (i.e., aqueous). In certain embodiments, the impregnating liquid 126 is an ionic liquid (e.g., BMI-IM). Other examples of possible impregnating liquids include hexadecane, vacuum pump oils (e.g., FOMBLIN® 06/6, KRYTOX® 1506), silicone oils (e.g., 10 cSt, 50 cSt, 200 cSt, 500 cSt, or 1000 cSt, for example), fluorocarbons (e.g., perfluoro-tripentylamine, FC-70), shear-thinning fluids, shear-thickening fluids, liquid polymers (e.g., polyethylmethacrylate (PEMA)), dissolved polymers, viscoelastic fluids, and/or liquid fluoroPOSS. In certain embodiments, the impregnating liquid is (or comprises) a liquid metal, a dielectric fluid, a ferro fluid, a magneto-rheological (MR) fluid, an electro-rheological (ER) fluid, an ionic fluid, a hydrocarbon liquid, and/or a fluorocarbon liquid, or any combination thereof.

The impregnating liquid 126 may be introduced to the surface 120 using any conventional technique for applying a liquid to a solid. In certain embodiments, a coating process, such as a dip coating, blade coating, or roller coating, is used to apply the impregnating liquid 126. Alternatively, the impregnating liquid 126 may be introduced and/or replenished by liquid materials flowing past the surface 120 (e.g., in a pipeline). After the impregnating liquid 126 has been applied, capillary forces stably hold the liquid in place. Capillary forces scale roughly with the inverse of feature-to-feature distance or pore radius, and the features may be designed such that the liquid is held in place despite movement of the surface and despite movement of air or other fluids over the surface (e.g., where the surface 120 is on the outer surface of an aircraft with air rushing over, or in a pipeline with oil and/or other fluids flowing therethrough). In certain embodiments, nano-scale features are used (e.g., 1 nanometer to 1 micrometer) where high dynamic forces, body forces, gravitational forces, and/or shearing forces could pose a threat to remove the liquid film, e.g., for surfaces used in fast flowing pipelines.

In some embodiments, a liquid-impregnated surface is configured such that the impregnating liquid submerges a portion of, or the entire, surface with solid features thereupon. As used herein, emerged area fraction 4 is defined as a representative fraction of the projected surface area of the liquid-impregnated surface corresponding to non-submerged solid at equilibrium. The term “equilibrium” as used herein refers to the condition in which the average thickness of the impregnating film does not change over time due to drainage by gravity when the substrate is held away from horizontal, and where evaporation is negligible (e.g., if the liquid impregnated liquid were to be placed in an environment saturated with the vapor of that impregnated liquid). Similarly, the term “pseudo-equilibrium” as used herein refers to the same condition except that evaporation may occur, or gradual dissolving. In certain embodiments, equilibrium is a relative term—e.g., some evaporation or gradual dissolving of impregnating liquid may be occurring, but the article is still considered to be “at equilibrium”. Note that the average thickness of a film at equilibrium may be less on parts of the substrate that are at a higher elevation, due to the decreased hydrostatic pressure within the film at increasing elevation. However, it will eventually reach an equilibrium or pseudo-equilibrium, in which the average thickness of any part of the surfaces is unchanging with time.

In general, a “representative fraction” of a surface refers to a portion of the surface with a sufficient number of solid features thereupon such that the portion is reasonably representative of the whole surface. In certain embodiments, a “representative fraction” is at least a tenth of the whole surface.

Referring to FIG. 3, a schematic cross-sectional view and the corresponding top view of a liquid-impregnated surface that is partially submerged is shown. The upper left drawing of FIG. 3 shows a cross-sectional view of a row of cone-shaped solid features. The projected surface area of the non-submerged solid 302 is illustrated as shaded areas of the overhead view, while the remaining non-shaded area represents the projected surface area of the submerged liquid-impregnated surface 300. In addition to the projection surface area of this row of solid features, other solid features placed in a semi-random pattern are shown in shade in the overhead view. Similarly, the cross-section view of a row of evenly spaced posts is shown on the right of FIG. 3. Additional rows of well-patterned posts are shown in shade in the overhead view. As demonstrated, in some embodiments of the present invention, a liquid-impregnated surface includes randomly and/or non-randomly patterned solid features.

In some embodiments discussed herein, a novel approach for imparting and/or improving scale-resistance using lubricant-impregnated surfaces in which a liquid lubricant is impregnated into a micro/nanotextured surface is illustrated. FIG. 10b shows such a lubricant-impregnated surface. The impregnated lubricant is stabilized by capillary forces arising from the microscopic texture and can impart remarkable mobility to droplets (or other motive phases) on the surface, provided the lubricant preferentially spreads on the solid. These types of surfaces have been shown to repel a variety of liquids, enhance condensation, reduce ice adhesion, and exhibit self-cleaning, among other properties and advantages. High capillary stabilization and self-healing properties make these surfaces robust enough to withstand harsh conditions, such as those in, e.g., oil pipelines or heat exchangers.

Some embodiments discussed herein relate to the control of gypsum scale deposition on surfaces exposed to supersaturated saline solutions. An untreated smooth surface experiences heavy scale deposition with a very high surface coverage (as seen in FIGS. 10c and 10e). In contrast, a lubricant-impregnated surface shows almost negligible scale deposition compared to an untreated surface, as shown in FIG. 10d. The corresponding SEM image of the lubricant-impregnated surface (shown in FIG. 10f) further shows almost negligible surface coverage of scale on the lubricant-impregnated surface. This remarkable performance of the lubricant-impregnated surface is a result of the texture and the impregnating lubricant (e.g., the choice of the lubricant, the amount of the lubricant, the manner of deposition of the lubricant, the combined properties of the lubricant/impregnating surface, etc.).

In certain embodiments, an apparatus or device (e.g., a vessel, such as a conduit, receptacle, pipeline, or the like) is provided that reduces or prevents the formation of mineral scale. The mineral scale may include, for example, calcium sulfate, calcium carbonate, barium sulfate, silica, iron, and/or other deposits and any combination thereof. In certain embodiments, the device reduces or prevents the formation of mineral scale by having a surface with a low surface energy, said surface having exposure to a mineral solution.

In certain embodiments, a method of retrofitting a device (e.g., a vessel) is provided for improved resistance to scale formation. The method may include modifying a surface of the device with a liquid-impregnated surface in accordance with the present invention.

In some embodiments, the invention relates to an article for use in industrial operation or research set-ups, the article having a surface with lowered surface energy. In certain embodiments, the article is a pipeline (or a part or coating thereof), and the surface is configured to inhibit scale formation thereupon. In certain embodiments, the article is a heat exchanger part or an oil or gas pipeline (or a part or coating thereof), and the surface is configured to inhibit scale formation thereupon.

### Experimental Examples

### Example 1

In this example, scaling experiments were conducted using calcium sulfate solution at a temperature of about 45° C. Bare smooth silicon, silanized silicon, silicon nanograss, silanized nanograss, and liquid impregnated surfaces were tested.

To systematically study scale formation on the test substrates, these substrates were immersed inside a 600 ml glass beaker. To reduce the surface energy of the dish and slides rack and prevent preferential scale formation, the substrates were coated with trichloro(1H,1H,2H,2H-perfluorooctyl)silane before the experiment. The glass beaker was filled with a saturated solution of CaSO₄ in water and placed on a multi-position hotplate (Ika Works IKAMAG RT 15 position Hot Plate). Temperature was set at 45° C. and controlled within ±3° C. of the set point. The experimental set-up allows the solutions to reach supersaturation through evaporation of the aqueous phase during the course of experiment (80 h).

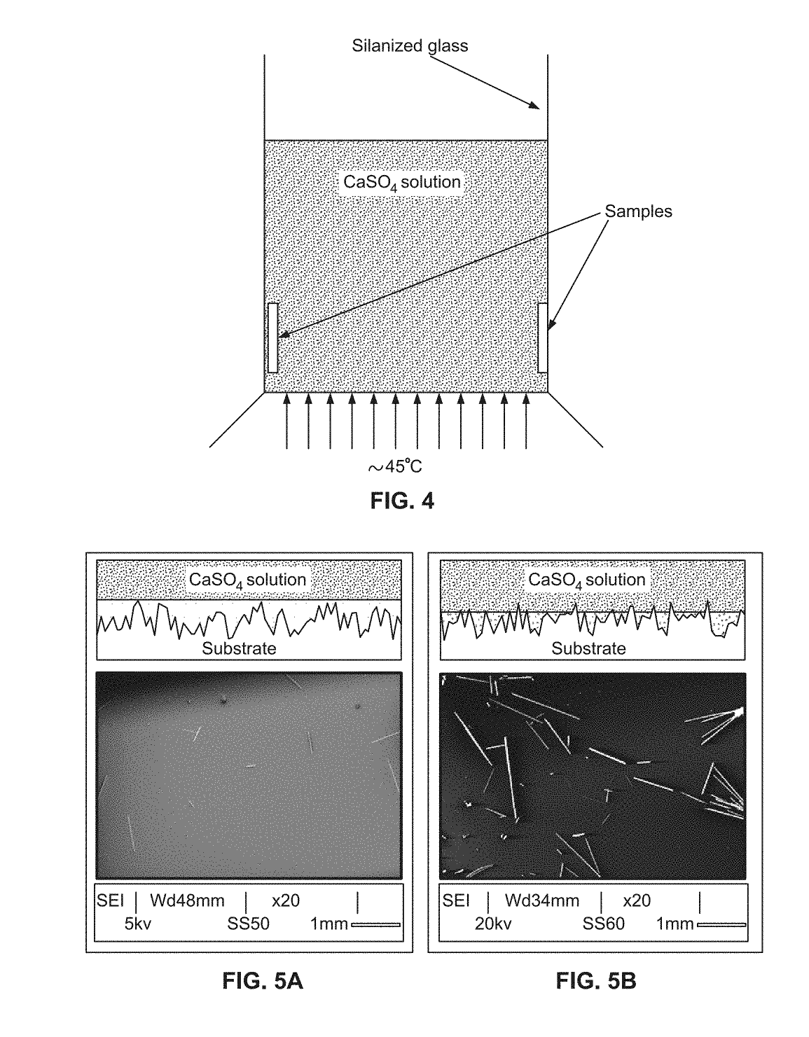

FIG. 4 shows a schematic illustration of the experimental set-up. Containers were made of glass and were coated with a low surface energy modifier (here, we used fluorosilane) to inhibit preferential nucleation of the salts.

The substrate samples were withdrawn at three time intervals (i.e., 33, 53, 80 h). The withdrawn substrate samples were air-dried and weighted using a high accuracy balance to quantify their weight change due to the deposition of CaSO₄ precipitates on their surfaces. To study their scale deposition qualitatively, substrate samples were also characterized using SEM (JSM-6610LV) at an accelerating voltage of 20 kV.

The nanograss was grown on smooth silicon substrates by dry etching, where the substrate was placed inside an inductively coupled plasma chamber with a controlled flow of etching gases (SF₆/O₂) for ˜10 min. The average width of the grass wires was ˜100 nm with spacing of ˜100-200 nm. Before liquid impregnation, the nanograss covered silicon was modified with OTS (octadecyltricholrosilane).

To fabricate the oil-encapsulated surface, the OTS coated nanograss samples were dip-coated in silicone oil (100 cSt), using a dip-coater (KSV Nima multi-vessel dip-coater). The dip-coated surfaces were retracted at a predetermined speed such that the capillary number was well below 10⁻⁵. This enabled the nanostructure to be effectively impregnated with the liquid.

Octadecyltricholrosilane (OTS) (90%) was purchased from Sigma Aldrich. Polyethylmethacrylate (PEMA) was purchased from Sigma Aldrich and was dissolved in Asahiklin—an organic solvent. Calcium sulfate dihydrate (99.4%) was purchased from J. T. Baker and dissolved directly in deionized water (18 MQ-cm, Millipore) to make the starting saturated solution. Silicone oil (100 cSt) was purchased from Sigma Aldrich.

A smooth silicon surface was textured with nano-features (nanograss) using reactive ion etching and the surface was then coated with octadecyltrichlorosilane (OTS) to lower its surface energy as discussed above. The nanograss substrates were then impregnated with two lubricants—Silicone oil (Sigma Aldrich—polydimethylsiloxane, surface tension at 25° C. is 20 mN/m), having a positive spreading coefficient on OTS and DC704 (Dow Corning—tetramethyl tetraphenyl trisiloxane, surface tension at 25° C. is 37.3 mN/m), having a negative spreading coefficient on OTS. Table 1 below shows the contact angles of the two lubricants on OTS, which are less than the critical contact angle Θ_{c}, resulting in stable impregnated states (Θ_{c}˜78° on nanograss). Because silicone oil has a low surface tension and a positive spreading coefficient, the resulting impregnated surface is in the most preferred state (state IV in FIG. 1d) for scale inhibition. In contrast, DC704 has a negative spreading coefficient and a higher surface tension, resulting in a state that is more susceptible to scale formation (state I in FIG. 1d).

TABLE 1
Contact angle data for the lubricants
on an OTS-treated smooth surface.

| Lubricant | Advancing (°) | Receding (°) |
|---|---|---|
| Silicone Oil | 0 | 0 |
| DC704 | 55 ± 1 | 42 ± 2 |

Scaling phenomenon was observed on surfaces with different impregnating liquids—silicone oil and a diffusion pump liquid (DC704). Silicone oil submerges the entire texture resulting in an extremely smooth surface with no exposed texture. Additionally, the impregnating liquid is a low surface tension liquid, and the amount of scale formed on this surface is observed to be very low (see FIG. 5a). In contrast, DC704 being a high surface tension liquid results in higher energy surface with the liquid that does not completely submerge the texture thus resulting in increased scaling compared to the silicone oil case (see FIG. 5b).

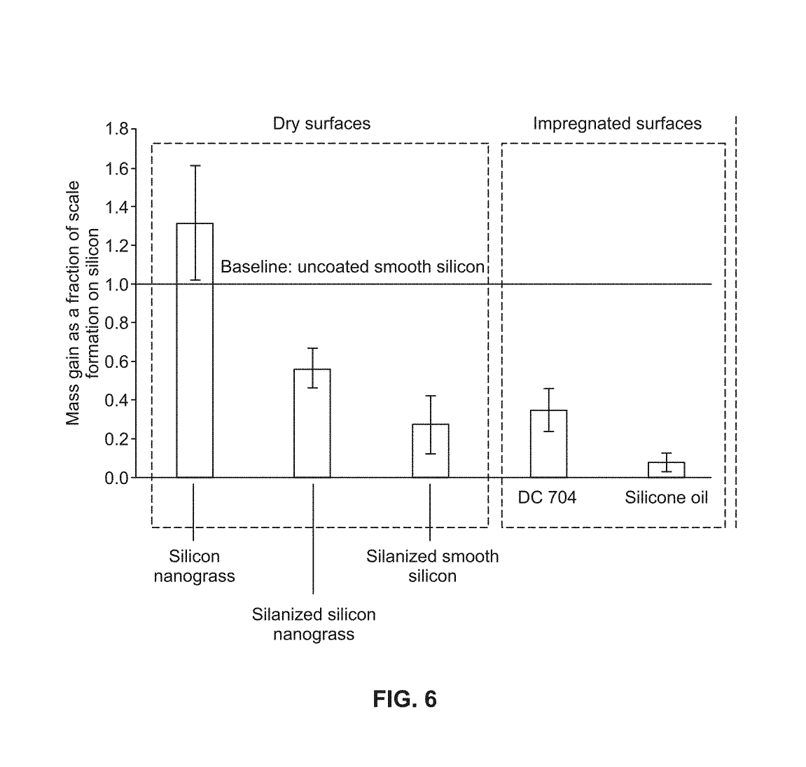

FIG. 6 includes two graphs showing mass gain due to scale formation on various substrates; the results are expressed as a fraction of the mass gain observed on uncoated smooth silicon. The scale deposition experiment was conducted on uncoated and silanized smooth silicon, uncoated and silanized nano-textured silicon, DC704-impregnated, and silicone oil-impregnated nano-textured silicon. Because of its low surface energy and limited density of nucleation sites, the results obtained with the silicone oil-impregnated surface were at least 10 times better than the uncoated smooth silicon substrate and uncoated nanograss silicon substrate in resisting scale formation. The silicone oil-impregnated surfaces had lesser scale formation than the silane-coated nanograss substrate, which is thought to be due to the increased roughness (higher density of nucleation sites) of the silanized nanograss silicon substrate. The performance of DC704-impregnated surface in resisting scale formation was worse than that of the silicone oil-impregnated surface. This is thought to be due to the presence of a high surface tension lubricant and higher density of nucleation sites, which is consistent with the results illustrated in FIG. 1d. The mass gain was due to calcium sulfate formation on the surfaces after being immersed in the salt solution for ˜80 hours, expressed as a normalized parameter with respect to silicon.

There was a significant reduction in the amount of scale formed on the liquid impregnated surfaces compared to the case of smooth silicon and rough silicon nanograss both in terms of mass gain and surface coverage. More specifically, the silicone oil-impregnated sample shows a better performance in comparison to the silanized smooth silicon samples. The data confirms that an impregnating liquid whose surface tension/surface energy density is below that of ˜20-25mJ/m² (e.g., OTS-silane), provide a better anti-scaling performance than the silanized smooth surface.

Along with a reduction in the total amount of scale formed, there is also a delay in the nucleation of the salt particles on the liquid impregnated surfaces compared to the bare smooth surface.

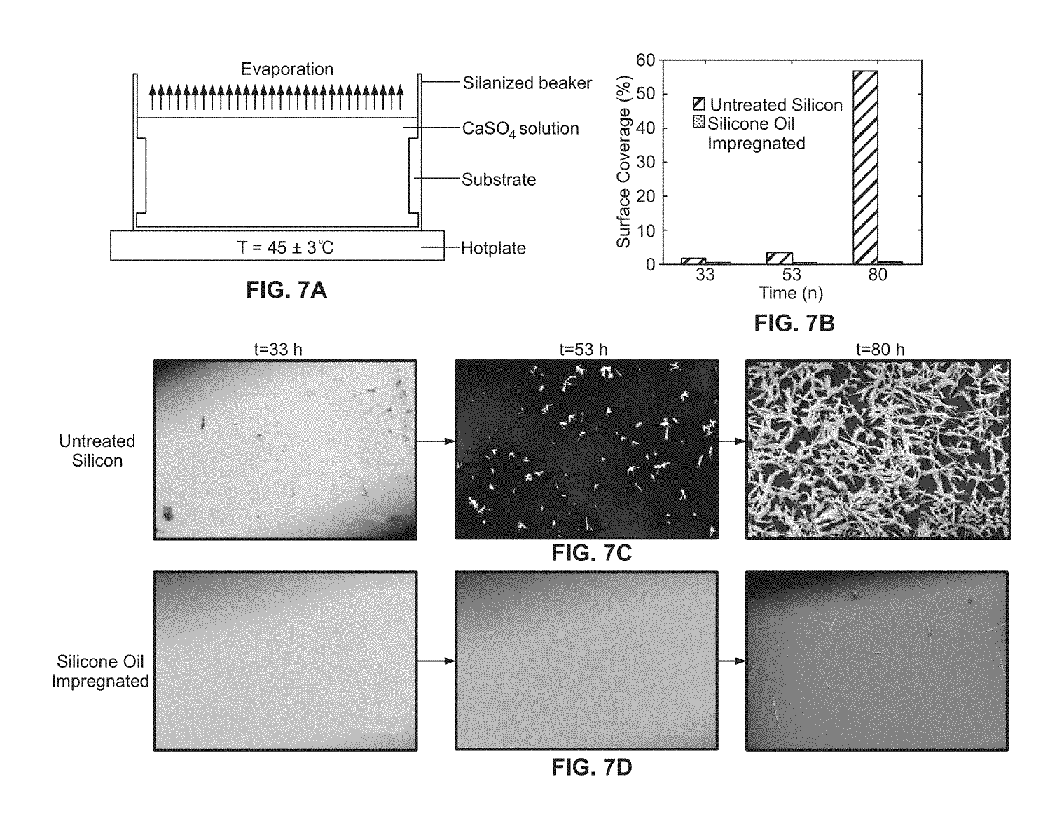

Calcium sulfate dihydrate (gypsum) was used in the experiments below to study scale deposition. The test substrates were immersed in a saturated solution of calcium sulfate dihydrate, and the entire system was maintained at an elevated temperature (see FIG. 7a). The supersaturation required for the nucleation of salt was achieved by the evaporation of the solution. The surface coverage of the scale deposited on an uncoated smooth silicon substrate was compared to that on a silicone oil-impregnated nano-textured silicon substrate sampled at three different times (33, 53 and 80 hours) during the experiment (see FIGS. 7c and 7d). The lower amount of scale formed on the lubricant-impregnated surface is thought to be due to the reduced nucleation rate. While nucleation had begun at ˜33 hours on smooth silicon (FIG. 7c), little to no nucleation was observed on the silicone oil-impregnated surface even after 53 hours (FIG. 7d). The corresponding surface coverage on the two surfaces at different times is shown in FIG. 7b (Image analysis done using ImageJ).

As illustrated by these images, the surface coverage is negligible on the silicone oil-impregnated surface compared to the uncoated smooth silicon, consistent with the nucleation theory presented herein. The reduced nucleation rate on silicone oil-impregnated surface is likely due to the low density of nucleation sites and a high activation barrier for nucleation (low-energy surface).

### Example 2

In this Example, scaling experiments were conducted on stainless steel and carbon steel. Carbon steel is a low cost structural material whose low corrosion resistance is a serious drawback in certain industrial applications. This example demonstrates that by texturing and liquid-impregnating stainless steel and carbon steel surfaces, such surfaces can be made to become more resistant to scale formation.

The experimental setup was similar to the one described for silicon substrates in Example 1.

Stainless-steel (type 304, ASTM A240, from Mcmaster) and carbon-steel (grade 1010, ASTM A109, also from Mcmaster) were sand-blasted using silica and alumina particles of 80 grit size for ˜3 min. The feature size of the sandblasted steel is roughly 10 μm. In certain embodiments, the feature size for liquid impregnation may be less than about 100 μm.

After sand-blasting, polyethylmethacrylate (PEMA) (surface energy density 33 J/m²) was used to modify the surface energy of steel substrates. The textured steel substrate was coated with PEMA to lower its surface energy and achieve a stable impregnation by silicone oil. PEMA dissolved in Asahiklin was applied on the steel substrates via spin coating with the substrate rotated at a speed of 1000 rpm.

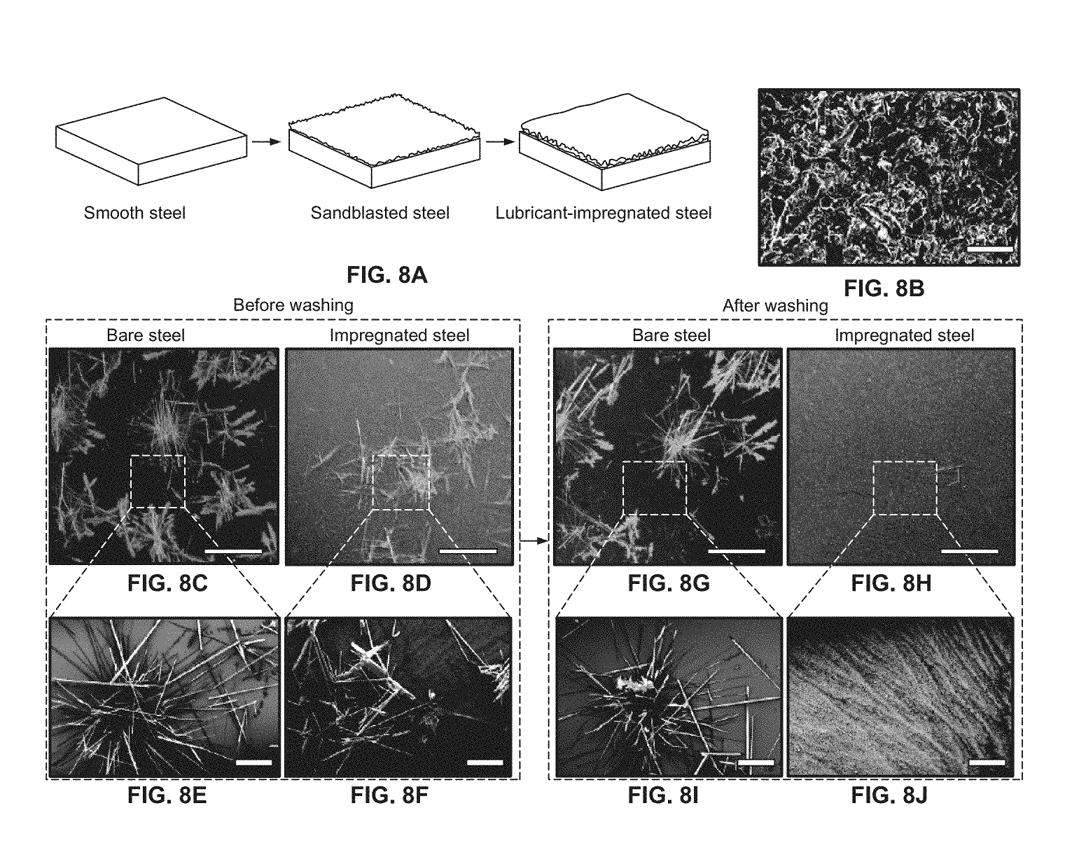

In addition to a schematic of liquid impregnation in steel, FIG. 8 shows an SEM image of sand-blasted stainless steel before impregnation with silicone oil (scale bar 50 μm). Also shown are photographs of bare stainless steel before washing (c) and after washing (d); photographs of the liquid-impregnated stainless steel before washing (g) and after washing (h). The corresponding SEM images of both bare steel ((e) and (f)) and the liquid-impregnated stainless steel ((i) and (j)) are shown as well. The adhesion of the salt particles to the liquid impregnated surface was observed to be extremely low compared to the bare stainless steel substrate, which indicates that the scale formed can easily be washed into the bulk.

The liquid within the textures lasted throughout the experiment (˜80 hours), and hence provides an indication of its longevity in these applications.

A decrease in the amount of scale formed on the lubricant-impregnated steel compared to an uncoated smooth steel surface was observed (as shown in FIGS. 8c, 8d). The two substrates were washed with a steady stream of water at a flow rate of ˜150 ml/min for ˜30 seconds. After washing, the lubricant-impregnated steel appeared scale-free (FIG. 8h), while the smooth uncoated stainless steel had significant deposits remaining on the surface (as seen in FIG. 8g). Thus, texturing techniques such as sandblasting assist in reducing scale deposition and also help lower the adhesion of scale to lubricant-impregnated surfaces.

In some embodiments, lubricant-impregnated surfaces with low or extremely low evaporation rates are used to prevent depletion of the lubricant. In some embodiments, the set-ups discussed above may be connected to a replenishing reservoir to replenish the lubricant if it becomes depleted or if the level of the lubricant falls below a predetermined threshold (or e.g., may be replenished periodically).

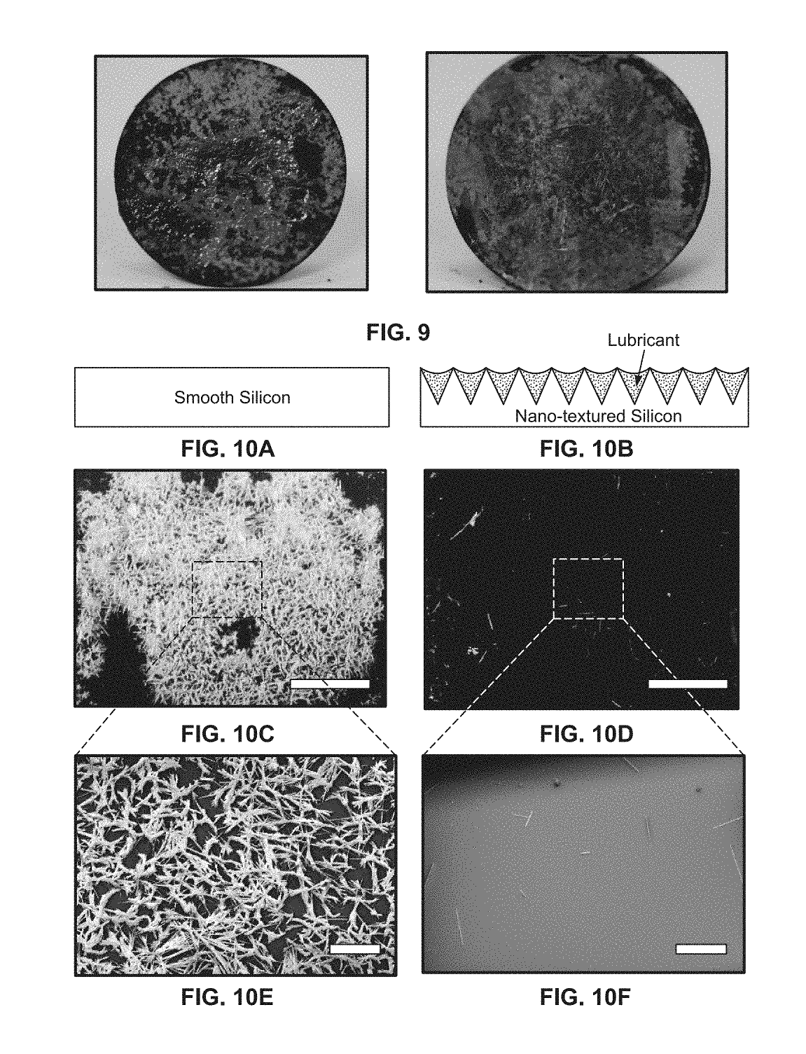

The liquid-impregnated carbon steel not only shows a decrease in the amount of scale formed on the surfaces, but it also provides better corrosion resistance, as shown in FIG. 9), making it very attractive in structural applications.

### EQUIVALENTS

While the invention has been particularly shown and described with reference to specific preferred embodiments, it should be understood by those skilled in the art that various changes in form and detail may be made therein without departing from the spirit and scope of the invention as defined by the appended claims.

1. A vessel for use in an industrial process, the vessel comprising a liquid-impregnated interior surface, wherein the liquid-impregnated surface comprises a matrix of features spaced sufficiently close to stably contain an impregnating liquid therebetween or therewithin and the impregnating liquid has a surface energy density γ (as measured at 25° C.) no greater than about 35 mJ/m², thereby providing resistance to mineral scale deposits thereupon.

2. The vessel of claim 1, wherein the liquid-impregnated surface comprises the matrix of features spaced sufficiently close to contain the impregnating liquid sufficiently well such that small quantities of impregnating liquid lost due to settling, evaporation, and/or dissolution of the impregnating liquid into one or more phases coming into contact with the surface can be replenished.

3. The vessel of claim 2, wherein the replenishment is achieved via contact with a reservoir comprising the impregnating liquid.

4. The vessel of claim 1, wherein the surface energy density γ (as measured at 25° C.) is no greater than about 30 mJ/m², no greater than about 25 mJ/m², or no greater than about 20 mJ/m².

5. The vessel of claim 1, wherein the liquid-impregnated surface of the vessel is in contact with a solution comprising a scale-forming mineral.

6. The vessel of claim 2, wherein the vessel is designed for use in a process in which the liquid-impregnated surface of the vessel contains, transfers, or is otherwise in contact with a solution comprising a scale-forming mineral.

7. The vessel of claim 1, wherein the impregnating liquid is immiscible with, or negligibly miscible with, the solution comprising the scale-forming mineral with which the interior surface of the vessel is designed to come into contact.

8. The vessel of claim 1, wherein the impregnating liquid is a lubricant and the interior surface is a textured substrate, wherein the liquid-impregnated interior surface of the vessel is configured, during operation, to come into contact with (or maintain contact with) a salt solution comprising a scale-forming mineral, and wherein the spreading coefficient S_{os(w)} of the impregnating lubricant (subscript ‘o’) on the substrate (subscript ‘s’) in the presence of the salt solution (subscript ‘w’) is greater than zero, such that the impregnating lubricant fully submerges the textured substrate.

9. The vessel of claim 1, wherein the vessel is designed for use in a process in which the liquid-impregnated surface of the vessel is in contact with a salt solution comprising a scale-forming mineral, or wherein the vessel contains a salt solution comprising a scale-forming mineral or transfers a salt solution comprising a scale-forming mineral.

10. The vessel of claim 1, wherein the impregnating liquid is a silicone oil.

11. The vessel of claim 1, wherein the liquid-impregnated surface is a scale-phobic surface that inhibits scale formation thereupon.

12. The vessel of claim 1, wherein the liquid-impregnated surface comprises a (solid) metal.

13. The vessel of claim 12, wherein the metal is selected from the group consisting of aluminum, steel, copper, titanium, tin, or any combination thereof.

14. The vessel of claim 1, wherein the impregnating liquid submerges the surface.

15. The vessel of claim 1, wherein the liquid-impregnated surface comprises a silane coating.

16. The vessel of claim 15, wherein the silane coating is a member selected from the group consisting of methylsilane, phenylsilane, isobutylsilane, dimethylsilane, tetramethyldisilane, hexylsilane, octadecylsilane, and fluorosilane.

17. The vessel of claim 1, wherein the liquid-impregnated surface is textured.

18. The vessel of claim 1, wherein the liquid-impregnated surface comprises micro-scale and/or nano-scale features.

19-23. (canceled)

24. A method of retrofitting a vessel for improved resistance to mineral scale deposits, the method comprising modifying the vessel to produce a liquid-impregnated surface, wherein the liquid-impregnated surface comprises a matrix of features spaced sufficiently close to stably contain an impregnating liquid therebetween or therewithin and the impregnating liquid has a surface energy density γ (as measured at 25° C.) no greater than about 35 mJ/m², thereby providing resistance to mineral scale deposits thereupon.

25-44. (canceled)

45. A method of using a vessel in an industrial process, the method comprising:
(a) providing a vessel comprising a liquid-impregnated surface, wherein the liquid-impregnated surface comprises a matrix of features spaced sufficiently close to stably contain an impregnating liquid therebetween or and the impregnating liquid has a surface energy density γ (as measured at 25° C.) no greater than about 35 mJ/m², thereby providing resistance to mineral scale deposits thereupon; and
(b) contacting the liquid-impregnated surface with a solution comprising a scale-forming mineral.

46-64. (canceled)
